(19) United States
(12) Patent Application Publication
(10) Pub. No.: US 2017/0217284 A1
(43) Pub. Date: Aug. 3, 2017

(54) AIR CLEANER FOR VEHICLES

(71) Applicant: DAECHANG CO., LTD., Jeongeup-si, Jeollabuk-do (KR)

(72) Inventors: Jun Dong JI, Gyeonggi-do (KR); Myeong Ji O, Gyeonggi-do (KR)

(21) Appl. No.: 15/112,186

(22) PCT Filed: Aug. 8, 2014
(86) PCT No.: PCT/KR2014/007408

§ 371 Date: Jul. 17, 2016

(30) Foreign Application Priority Data
Apr. 29, 2014 (KR) 10-2014-0051461
Jun. 3, 2014 (KR) 10-2014-0067505
Jul. 29, 2014 (KR) 10-2014-0096420
Aug. 5, 2014 (KR) 10-2014-0100232

(51) Int. Cl. B60H 1/00; B60H 3/06

(52) U.S. Cl. CPC B60H 1/00821; B60H 3/0658; B60H 1/00764; B60H 1/00428; B60H 1/00978; B60H 1/00321; B60H 1/00564; B60H 1/00457; B60H 2003/0675

(57) ABSTRACT

An air cleaning apparatus mounted to an internal automobile structure selected from an armrest, a console, a seat, a headrest, an overhead console, a handle, and a door, includes an air inflow unit arranged in the internal automobile structure, through which air inside an automobile is introduced, an air cleaning unit which is arranged in the internal vehicle structure and filters the introduced air inside the automobile, a first air flow path arranged in the internal automobile structure, through which the air, having been introduced through the air inflow unit and filtered by the air cleaning unit, is discharged to the interior of the automobile, and a second air flow path arranged in the internal automobile structure, through which blowing air, having been introduced to the internal automobile structure and not having passed through the air cleaning unit, is discharged to the interior of the automobile.

### TECHNICAL FIELD

Embodiments of the present invention relate to an air blowing technology, and more particularly, to an air cleaning apparatus for a vehicle.

### BACKGROUND ART

Recently, air cleaners which purify air inside vehicles have been mounted in vehicles. Generally, users may operate air cleaners after riding in vehicles. However, when users operate air cleaners after riding in vehicles, a certain time is necessary for making the inside of vehicles pleasant while users are exposed to polluted environments inside vehicles. Also, heaters or air conditioners for warming up or cooling down insides of vehicles are mounted in vehicles. However, since conventional heaters and air conditioners have large sizes, mounting positions in vehicles are limited and large amounts of time are necessary to increase or decrease temperatures of heaters and air conditioners to certain degrees. Due to this, passengers in vehicles have inconvenience of enduring the cold or the heat for a certain time and power consumption increases.

### PRIOR ART DOCUMENT

Korean Patent Publication No. 10-2002-0017295 (Mar. 7, 2002)

Korean Registered Utility Model Publication No. 20-0352604 (Jun. 9, 2004)

### DISCLOSURE OF THE INVENTION

### Technical Problem

Embodiments of the present invention provide an air cleaning apparatus for a vehicle, capable of purifying air inside the vehicle before riding of a user.

Embodiments of the present invention provide an air cleaning apparatus for a vehicle, capable of reducing power consumption and improving convenience of a user.

### Technical Solution

One aspect of the present invention provides an air cleaning apparatus for a vehicle, mounted on an internal structure of the vehicle selected from an armrest, a console, a seat, a headrest, an overhead console, a steering wheel, and a door, including an air inlet provided in the internal structure of the vehicle, through which air inside the vehicle flows in, an air cleaning unit provided in the internal structure and filtering the air inside the vehicle which flows therein, a first air flow path provided in the internal structure and through which the air, which flows in through the air inlet and is filtered by the air cleaning unit, is discharged into the vehicle, and a second air flow path provided in the internal structure and through which blown air, which flows into the internal structure and does not pass through the air cleaning unit, is discharged into the vehicle.

The apparatus may further include a heat exchange module provided in the internal structure of the vehicle, heat-exchanging with at least one of the air inside the vehicle and air discharged by an air conditioning unit of the vehicle, and discharging the heat-exchanged air into the vehicle.

The apparatus may further include a first fan which is provided at the first air flow path and allows the air inside the vehicle to flow into the air inlet portion, and a second fan which allows at least one of the air inside the vehicle and the air discharged by the air conditioning unit of the vehicle to flow into the internal structure of the vehicle.

The apparatus may include an air cleaning function of discharging the filtered air into the vehicle and an air blowing function of discharging the blown air into the vehicle, which are reserved and operated in connection with whether a user getting in is detected.

The apparatus may further include an air flow cushion portion which is provided in the internal structure of the vehicle wherein the filtered air or the blown air moves through the air flow cushion portion so that the filtered air or the blown air is discharged into the vehicle.

The apparatus may further include a lighting unit provided in the internal structure of the vehicle, and the lighting unit may provide information related to the filtered air and the blown air.

Another aspect of the present invention provides an air cleaning apparatus for a vehicle mounted in an internal structure of the vehicle selected from an armrest, a console, a seat, a headrest, an overhead console, a steering wheel, and a door, including an air cleaning unit which is provided in the internal structure of the vehicle and suctions and filters air inside the vehicle, an air outlet which is provided in the internal structure of the vehicle and discharges the filtered air into the vehicle, and a heat exchange module which is provided at the air outlet portion and heat-exchanges with air which passes through the air outlet portion.

The apparatus may further include an ultraviolet (UV) emitting unit which is provided in the internal structure of the vehicle and emits UV rays toward the air cleaning unit. Here, the air cleaning unit may include a dust filter which filters the air inside the vehicle and includes a photocatalyst reacting with the UV rays and generating a sterilizing material and a fan which allows the air inside the vehicle to flow into the dust filter and discharges the filtered air through the air outlet.

The apparatus may further include a fan control unit which allows the filtered air to be discharged toward a seat in which a passenger sits among seats provided in the vehicle.

At least one of whether to operate and an operational intensity of the air cleaning unit is controlled depending on dust concentration information of a corresponding area according to a position of the vehicle.

Still another aspect of the present invention provides an air cleaning apparatus for a vehicle, including an air cleaner mounted in a vehicle, a reservation setting unit which receives reservation information which includes at least one of operation starting information and operation time information of the air cleaner and reserves an operation of the air cleaner according to the reservation information, and a control unit which controls the operation of the air cleaner according to the reservation information.

The apparatus may further include a power supply unit which supplies power to the apparatus and a power source switching unit electrically connected to any one power supply source of a battery of the vehicle and the power supply portion depending on whether the vehicle starts and allowing the apparatus to receive the power from the power supply source electrically connected to.

The power source switching unit may be electrically connected to the power supply portion when an ignition of the vehicle is turned off and may be electrically connected to the battery of the vehicle when the ignition of the vehicle is turned on.

The operation time information may include an operation maintenance time of the air cleaner, and the control unit may change the operation maintenance time of the operation time information according to a correlation between a contamination degree inside the vehicle and the operation maintenance time.

The control unit may operate the air cleaner according to the reservation information and may determine whether to keep operating the air cleaner depending on whether at least one event of turning on the vehicle, unlocking a door lock of the vehicle, and sensing a smart key of the vehicle during a preset time between an operation starting point in time of the air cleaner and an operation completion time of the air cleaner according to the reservation information.

Yet another aspect of the present invention provides an air cleaning apparatus for a vehicle, provided at a steering wheel of the vehicle, including a fan which is formed on one side of the steering wheel and blows air inside the vehicle into the steering wheel, an air movement path which is formed in the steering wheel and extends along a frame of the steering wheel to provide a movement path of the air blown by the fan, and a plurality of air outlets which are formed on at least one side of the air movement path and discharge the blown air outward from the steering wheel.

The plurality of air outlets may include portions which are connected to an outside of the steering wheel and extend farther than portions connected to the air movement path.

The apparatus may further include an air blowing module which is formed to be adjacent to the air outlets and blow the air discharged from the air outlets outward from the steering wheel.

The apparatus may further include a manipulation switch portion for adjusting at least one of a blowing position, a blowing level, and a temperature of the air discharged through the air outlets.

The air cleaning apparatus may further include an input unit which receives a reservation time from the user, and the fan may operate at the reservation time input by the user.

A further aspect of the present invention provides an air cleaning apparatus for any vehicle, mounted in a console in a vehicle, including an air cleaning unit which includes a dust filter provided in the console and filtering air inside the vehicle and a fan suctioning the air inside the vehicle into the dust filter, an air outlet portion which is provided in the console and discharges the filtered air into the vehicle, and a heat exchange module which is provided at the air outlet portion and includes a thermoelectric element to heat-exchange air passing through the air outlet portion (the air inside the vehicle or air supplied by an air conditioning unit of the vehicle).

### Advantageous Effects

According to embodiments of the present invention, an air cleaning apparatus applied to an armrest of a vehicle suctions air inside the vehicle and filters and discharges, thereby purifying the air inside the vehicle through the armrest (or console, etc.). Since the air cleaning apparatus for the vehicle is mounted in a position adjacent to a passenger such as being in contact with a part of a body of the passenger, it is possible to make air around the passenger fresh through the air cleaning apparatus for the vehicle. Here, ions and ozone are discharged together with filtered air, thereby sterilizing the inside of the vehicle.

Also, the air cleaning apparatus for the vehicle includes a heat exchange module, thereby autonomously discharging cool air or warm air from the air cleaning apparatus for the vehicle separate from an air conditioning apparatus of the vehicle. Also, an air cleaning function and a heat-exchanged air blowing function are reserved and operated in connection with sensing whether a user rides in the vehicle, thereby preparing a pleasant environment of the inside of the vehicle when the user rides in the vehicle and maintaining a user-friendly temperature of the inside of the vehicle while the user drives the vehicle.

Also, the air cleaning apparatus for the vehicle includes an autonomous power source supply means, thereby operating to purify the air inside the vehicle while the ignition of the vehicle is turned off. Also, since the air cleaning apparatus for the vehicle is provided in an overhead console, space utilization of the inside of the vehicle may be enhanced. Also, by forwarding ions, a sterilizing material, purified air from a high position in the vehicle, the air inside the vehicle is allowed to smoothly circulate in the vehicle to quickly purify the inside of the vehicle.

Also, by discharging heat-exchanged air into the inside of the vehicle through a steering wheel of the vehicle, the heat-exchanged air may be efficiently supplied to the user who sits in a driver's seat. Due to this, a time in which the user endures the cold or the heat may be reduced, and as a result, power consumption according to heat exchange may be reduced. Also, air blowing into the inside of the vehicle may be efficiently performed by adjusting an air blowing position, air blowing strength, and a temperature of air discharged outward from the steering wheel using an operation switch portion.

Also, an air outlet is formed to be enlarged toward an outside of the steering wheel of the vehicle, thereby preventing a fore-end of the air outlet from being blocked by a hand (or a finger) of the user. An air blowing fan is operated only at a reserved time input by the user through an input portion, thereby preventing unnecessary power consumption.

### BRIEF DESCRIPTION OF DRAWINGS

FIG. 1 is an exploded perspective view of an armrest apparatus for a vehicle according to a first embodiment of the present invention.

FIG. 2 is a cross-sectional view of the armrest apparatus for the vehicle according to the first embodiment of the present invention.

FIG. 3 is a perspective view of a cover portion of the armrest apparatus for the vehicle according to the first embodiment of the present invention.

FIG. 4 is a cross-sectional view of an armrest apparatus for a vehicle according to a second embodiment of the present invention.

FIG. 5 is a view illustrating a state of suctioning and then discharging air at the armrest apparatus for the vehicle according to an embodiment of the present invention.

FIG. 6 is a view illustrating a state of discharging ions from the armrest apparatus for the vehicle according to the embodiment of the present invention.

FIG. 7 is a view illustrating a state of illuminating by the armrest apparatus for the vehicle according to the embodiment of the present invention.

FIG. 8 is a schematic diagram illustrating an example of a heat exchange module in the armrest apparatus for the vehicle according to the embodiment of the present invention.

FIG. 9 is a cross-sectional view of an armrest apparatus for a vehicle according to a third embodiment of the present invention.

FIG. 10 is a cross-sectional view of an armrest apparatus for a vehicle according to a fourth embodiment of the present invention.

FIG. 11 is a block diagram illustrating components of an air cleaning apparatus according to embodiments of the present invention.

FIG. 12 is a view illustrating a state in which an air cleaning apparatus for a vehicle according to one embodiment of the present invention is applied to an overhead console.

FIG. 13 is a schematic diagram illustrating an overhead console apparatus according to one embodiment of the present invention.

FIG. 14 is a schematic diagram illustrating an overhead console apparatus according to another embodiment of the present invention.

FIG. 15 is a view of a steering wheel apparatus of a vehicle according to embodiments of the present invention.

FIG. 16 is an enlarged view illustrating a part A shown FIG. 15.

FIG. 17 is an enlarged view illustrating a part B shown in FIG. 16.

FIG. 18 is a view illustrating a state in which heat-exchanged air is discharged from a certain portion of the steering wheel apparatus of the vehicle according to embodiments of the present invention.

FIG. 19 is a view illustrating another example in which heat-exchanged air is discharged from a certain portion of the steering wheel apparatus of the vehicle according to embodiments of the present invention.

FIG. 20 is a view illustrating a process in which air inside the vehicle flows into an air flow path in the steering wheel apparatus of the vehicle according to embodiments of the present invention.

FIG. 21 is a perspective view of a heat exchange module according to the first embodiment of the present invention.

FIG. 22 is a perspective view of a heat exchange module according to the second embodiment of the present invention.

FIG. 23 is a view of a heater according to one embodiment of the present invention.

### MODE FOR INVENTION

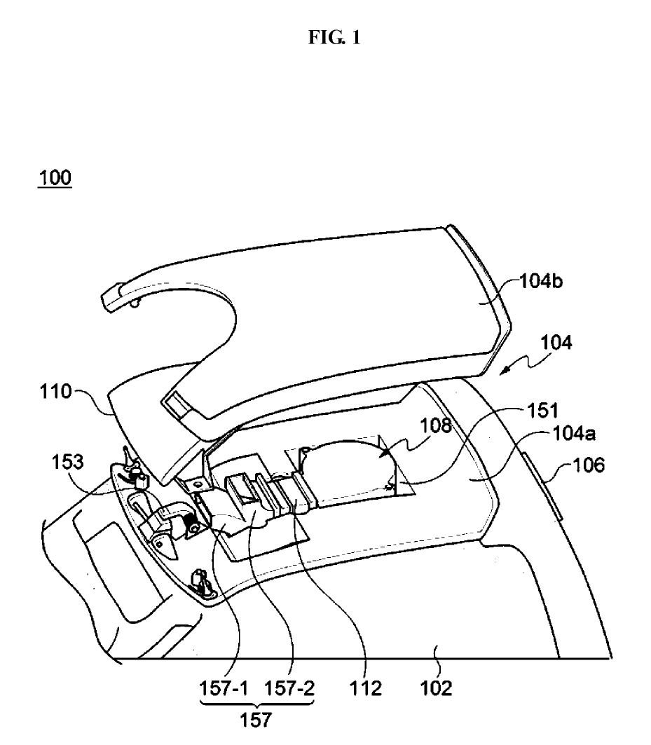

Hereinafter, referring to FIGS. 1 to 23, air cleaning apparatuses for vehicles according to embodiments of the present invention will be described in detail. However, they are merely exemplary embodiments and the present invention is not limited thereto. In the description of the embodiments, certain detailed explanations of the related art are omitted when it is deemed that they may unnecessarily obscure the essence of the present invention. Also, the terms described below are defined considering functions thereof in the embodiments, which may vary with intentions of a user and an operator or practice. Accordingly, definitions thereof will be given based on the contents throughout the specification.

The technical concept of the present invention is defined by the claims. Following embodiments are used merely to efficiently explain the technical concept of the present invention to one of ordinary skilled in the art.

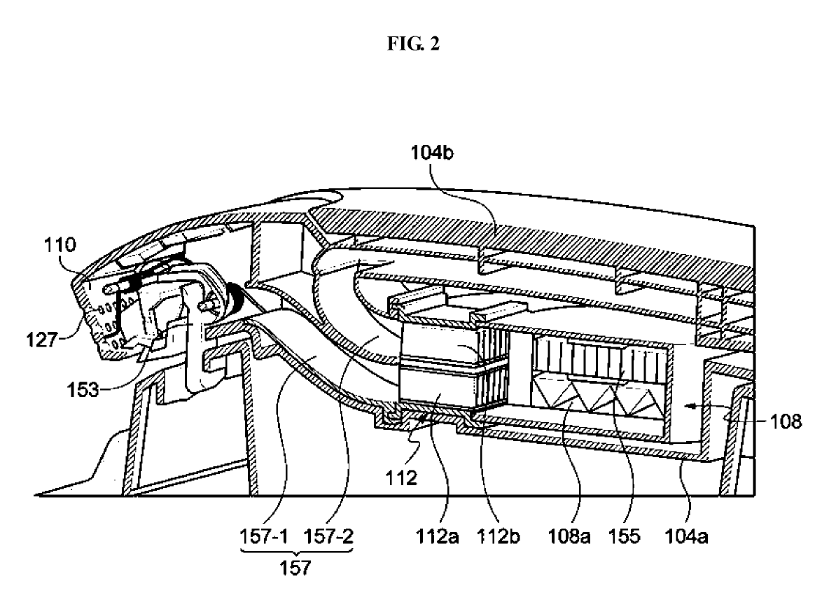

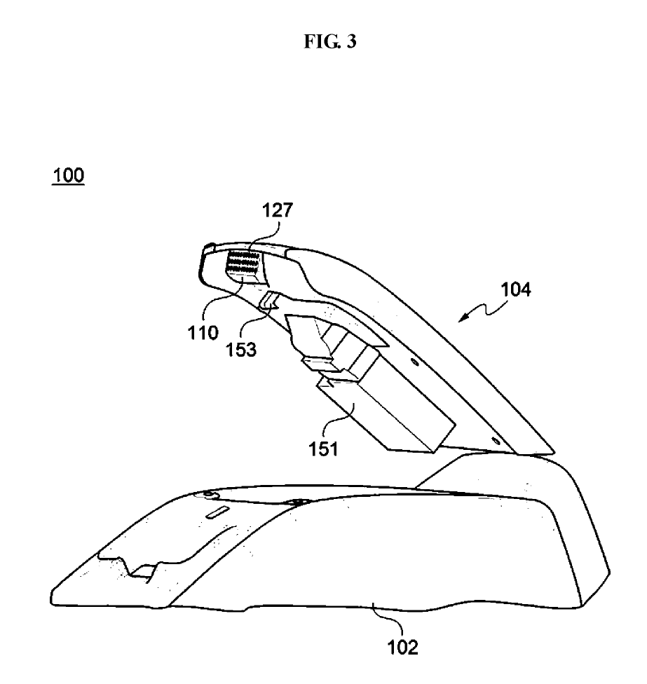

FIG. 1 is an exploded perspective view of an armrest apparatus for a vehicle according to a first embodiment of the present invention, FIG. 2 is a cross-sectional view of the armrest apparatus for the vehicle according to the first embodiment of the present invention, and FIG. 3 is a perspective view of a cover portion of the armrest apparatus for the vehicle according to the first embodiment of the present invention. Here, as an example, a case in which an air cleaning apparatus for a vehicle is applied to an armrest in the vehicle will be described. However, an application range and target of the air cleaning apparatus for the vehicle are not limited thereto.

Referring to FIGS. 1 to 3, an armrest apparatus 100 of a vehicle may include a storage portion 102, a cover portion 104, an air inlet portion 106, an air cleaning unit 108, an air outlet portion 110, and a heat exchange module 112.

Here, the armrest apparatus 100 includes not only an armrest of a vehicle but also a console box of a vehicle (for example, a center console, etc.). The armrest apparatus 100 may be provided in at least one of a space between front seats of the vehicle or a space between rear seats of the vehicle. The armrest apparatus 100 may be provided on a side portion of a seat of the vehicle. Also, the armrest apparatus 100 may be provided at a door of the vehicle. For example, the armrest apparatus 100 may be provided at a door armrest.

The storage portion 102 is provided inside the armrest apparatus 100. The storage portion 102 includes a storage space for storing articles (for example, a water bottle, a can, a portable device, etc.). Here, the armrest apparatus 100 has been described as including the storage portion 102 but is not limited thereto and may not include the storage portion 102.

The cover portion 104 may be provided above the storage portion 102. The cover portion 104 may be provided to open and close a top of the storage portion 102. The cover portion 104 may become a portion on which a passenger in the vehicle rests a part of his or her body (for example, an arm, a hand, etc.). The cover portion 104 may be pivotably hinge-coupled with one side of the armrest apparatus 100. Here, the cover portion 104 may be hinge-coupled with an adjustable pivoting angle. For example, the cover portion 104 may be provided with the pivoting angle adjustable by a certain angle (for example, 10° or 30°, etc.). In this case, the cover portion 104 may pivot at an angle desired by the passenger of the vehicle and then may be fixed. However, the cover portion 104 is not limited thereto and may be slidably coupled with the armrest apparatus 100.

The cover portion 104 may include a lower cover case 104a and an upper cover case 104b. The lower cover case 104a may be provided to be mounted on a top end of the storage portion 102. An accommodating portion 151 in which the air cleaning unit 108 and the heat exchange module 112 are accommodated may be provided in the lower cover case 104a. The accommodating portion 151 may protrude downward from the lower cover case 104a to provide a space for accommodating the air cleaning unit 108 and the heat exchange module 112. A holding portion 153 for coupling the cover portion 104 with a body of the armrest apparatus 100 may be provided at a front end of the lower cover case 104a. The holding portion 153 may be hook-coupled with the body of the armrest apparatus 100. The upper cover case 104b may be coupled with the lower cover case 104a at the top of the lower cover case 104a.

The air inlet portion 106 may allow air inside the vehicle to flow into the armrest apparatus 100. The air inlet portion 106 may allow the air inside the vehicle to flow to the air cleaning unit 108 through a fan 155. One side of the air inlet portion 106 may be opened from the armrest apparatus 100 toward the inside of the vehicle. That is, the one side of the air inlet portion 106 may be connected to the inside of the vehicle at the armrest apparatus 100. The other side of the air inlet portion 106 may be connected to the air cleaning unit 108. The air inlet portion 106 may allow air inside the vehicle to flow thereinto at a rear end of the armrest apparatus 100. However, the air inlet portion 106 is not limited thereto and may allow the air inside the vehicle to flow therein at a side or a front end of the armrest apparatus 100.

The air cleaning unit 108 performs a function of purifying the air inside the vehicle which flows in through the air inlet portion 106. The air cleaning unit 108 may include a dust filter 108a. The dust filter 108a may be accommodated in a space connected to the air inlet portion 106. The dust filter 108a may filter out fine dust, yellow dust, foreign substances, etc. included in the air inside the vehicle which flows in through the air inlet portion 106 to purify the air inside the vehicle.

Here, the air purified through the dust filter 108a is to be blown to the air outlet portion 110 by the fan 155. That is, the fan 155 performs a function of discharging the air inside the vehicle filtered by the dust filter 108a to the outside of the vehicle through the air outlet portion 110. The fan 155 may be provided on one side of the dust filter 108a. Also, the fan 155 may allow the air inside the vehicle to flow into the air inlet portion 106. The fan 155 may be operated depending on a contamination degree inside the vehicle. For example, when the contamination degree inside the vehicle exceeds a preset value, the fan 155 allows the air inside the vehicle to flow into the air inlet portion 106, be filtered by the dust filter 108a, and then be discharged through the air outlet portion 110. Here, the fan 155 may adjust operation intensity depending on the contamination level inside the vehicle.

Also, the fan 155 may operate according to dust concentration information transferred from the vehicle and may allow the air inside the vehicle to flow into the air inlet portion 106. Here, the fan 155 may be adjusted in operation intensity depending on the dust concentration information. In detail, the vehicle may receive dust concentration information of an area corresponding to a position of the vehicle. For example, the vehicle may receive position information of the vehicle from a global positioning system (GPS) installed in the vehicle. Next, the vehicle may transmit the position information of the vehicle to an external server (that is, a server for managing dust concentration information of a corresponding area) to request the dust concentration information of the corresponding area. Next, the vehicle may receive and transmit the dust concentration information of the corresponding area from the external server to the armrest apparatus 100. Then, the armrest apparatus 100 may operate the fan 155 depending on the dust concentration information.

Hereinafter, a case of classifying dust concentration into stages such as “good”, “ordinary”, “little bad”, “bad”, and “very bad” will be described. For example, when the dust concentration information of the corresponding area is “little bad” or less, the armrest apparatus 100 operates the fan 155 and starts filtering the air inside the vehicle using the dust filter 108a. Here, when the dust concentration information of the corresponding area is in a state worse than “little bad” (for example, “bad” or “very bad”), the operation intensity of the fan 155 becomes stronger to increase a speed of filtering the air inside the vehicle.

The air outlet portion 110 performs a function of discharging the air filtered (that is, purified) by the air cleaning unit 108 into the vehicle. The air outlet portion 110 may be provided on the front end of the armrest apparatus 100. For example, the air outlet portion 110 may be provided at a front end of the cover portion 104. Here, the air outlet portion 110 may be provided at the front end of the cover portion 104 between the lower cover case 104a and the upper cover case 104b. One side of the air outlet portion 110 may be connected to the air cleaning unit 108 through an air transfer portion 157. The other side of the air outlet portion 110 may be provided to be connected to the inside of the vehicle. At least one air hole 127 may be provided in the air outlet portion 110.

Here, the air outlet portion 110 has been described as being provided at the front end of the cover portion 104 but is not limited thereto and may be provided at a top of the cover portion 104. Here, the air outlet portion 110 provided at the front end of the cover portion 104 may be connected to the air cleaning unit 108 through a first air transfer portion 157-1. Also, the air outlet portion 110 provided at the top of the cover portion 104 may be connected to the air cleaning unit 108 through a second air transfer portion 157-2.

The heat exchange module 112 may be provided on a path through which the air filtered by the air cleaning unit 108 is discharged through the air outlet portion 110. For example, the heat exchange module 112 may be provided in the air transfer portion 157 which connects the air cleaning unit 108 and the air outlet portion 110. The heat exchange module 112 may heat-exchange the air inside the vehicle which flows in through the air inlet portion 106. The heat exchange module 112 may cool or heat the air inside the vehicle which flows in through the air inlet portion 106. Here, the fan 155 may discharge the air heat-exchanged by the heat exchange module 112 (that is, cool air or warm air) into the vehicle through the air outlet portion 110. In this case, separate from an air conditioning apparatus of the vehicle, the armrest apparatus 100 may autonomously discharge cool air or warm air into the vehicle. The heat exchange module 112 may be provided to adjust a temperature of the cool air or the warm air discharged through the air outlet portion 110.

The heat exchange module 112 may include a first thermoelectric element (not shown), a first heat exchange portion 112a provided on one side of the first thermoelectric element, a second thermoelectric element (not shown), and a second heat exchange portion 112b provided on one side of the second thermoelectric element. The first thermoelectric element may cool or heat the first heat exchange portion 112a. The second thermoelectric element may cool or heat the second heat exchange portion 112b. The second heat exchange portion 112b may be provided above the first heat exchange portion 112a. That is, the first heat exchange portion 112a and the second heat exchange portion 112b may be provided in a multilayer structure. Here, the first heat exchange portion 112a may be provided in the first air transfer portion 157-1. In this case, the cool air or warm air of the first heat exchange portion 112a may be discharged into the vehicle through the air outlet portion 110 provided at the front end of the cover portion 104. The second heat exchange portion 112b may be provided in the second air transfer portion 157-2. Here, the cool air or warm air of the second heat exchange portion 112b may be discharged into the vehicle through the air outlet portion 110 provided at the top of the cover portion 104.

Here, the heat exchange module 112 has been described as including the thermoelectric elements to cool or heat the air inside the vehicle but is not limited thereto and may include a heating portion (not shown). The heating portion, for example, may be a metal thin film, a heating wire, etc. but is not limited thereto. Here, the heat exchange module 112 may include an overheating-preventing portion (not shown) for preventing the heating portion from being overheated. Also, here, the heat exchange module 112 has been described as heat-exchanging the air inside the vehicle which flows in through the air inlet portion 106 but is not limited thereto and may be connected to an air conditioning duct (not shown) of the vehicle and may heat-exchange air discharged from an air conditioning unit of the vehicle.

Here, the air cleaning unit 108 and the heat exchange module 112 may be provided on a path between the air inlet portion 106 and the air outlet portion 110 (that is, a path through which the air which flows in through the air inlet portion 106 is discharged through the air outlet portion 110). Also, the fan 155 may be provided to discharge at least one of the air filtered by the air cleaning unit 108 and the air heat-exchanged by the heat exchange module 112 into the vehicle through the air outlet portion 110. For example, the fan 155 may be provided together with the air cleaning unit 108 and the heat exchange module 112 on the path between the air inlet portion 106 and the air outlet portion 110.

The fan 155 may selectively discharge the air filtered by the air cleaning unit 108 and the air heat-exchanged by the heat exchange module 112 into the vehicle through the air outlet portion 110. That is, the air cleaning function of the air cleaning unit 108 and the heat-exchanged air blowing function of the heat exchange module 112 may be selectively performed by the armrest apparatus 100. That is, the armrest apparatus 100 may include driving buttons for operating the air cleaning function of the air cleaning unit 108 and the heat-exchanged air blowing function of the heat exchange module 112.

That is, the air cleaning function of the air cleaning unit 108 and the heat-exchanged air blowing function of the heat exchange module 112 may be operated through a reservation function at the armrest apparatus 100. For example, the air cleaning function of the air cleaning unit 108 may be reserved and set to operate for a preset time before sensing riding of a user. The user may reserve settings for operating the air cleaning function for a preset time before going to work or getting off work. Here, the riding of the user may be sensed by sensing whether a door of the vehicle is opened by the user or whether the user takes a seat in the vehicle, etc. The air cleaning function may be operated for the preset time before sensing the riding of the user and may stop after sensing the riding of the user.

The riding of the user may be sensed in connection with a vehicle smart key system. For example, the vehicle smart key system may transmit a wakeup signal, may receive unique authentication information from a smart key carried by the user, and may send a door-unlocking signal to the armrest apparatus 100 when to unlock a door lock. However, it is not limited thereto and the armrest apparatus 100 may turn off the air cleaning function which is reserved-operated when a signal of sensing that the user takes a seat is transmitted from a seat-taking sensor (that is, seat-taking of the user is sensed).

Also, the heat-exchanged air blowing function of the heat exchange module 112 may be reserved and set to be operated for a preset time after the air cleaning function is reserved-operated and turned off That is, the heat-exchanged air blowing function may be operated in connection with sensing the riding of the user. As described above, the air cleaning function and the heat-exchanged air blowing function may be sequentially operated in connection with whether the riding of the user is sensed.

Here, the air cleaning function has been described as being operated before sensing the riding of the user and the heat-exchanged air blowing function has been described as being operated in connection with sensing the riding of the user but are not limited thereto. The heat-exchanged air blowing function may be operated before sensing the riding of the user and the air cleaning function may be operated in connection with sensing the riding of the user. Also, here, the air cleaning function and the heat-exchanged air blowing function have been described as being sequentially operated but are not limited thereto and may be operated together.

The armrest apparatus 100 may receive power from a battery mounted in the vehicle (that is, a vehicular storage battery). Here, the armrest apparatus 100 may be directly connected to the battery to directly receive power from the battery or may indirectly receive power through another device in the vehicle which receives the power from the battery. The armrest apparatus 100 may include a battery discharge preventing portion (not shown). Here, the battery discharge preventing portion prevents the battery mounted in the vehicle from being discharged. For example, when a voltage of the battery becomes a preset threshold value or less, the battery discharge preventing portion prevents power supply from the battery to prevent the battery from being discharged.

The armrest apparatus 100 may include a first air flow path through which the air inside the vehicle which flows in through the air inlet portion 106 is discharged into the vehicle again after being filtered by the air cleaning unit 108. The filtered air may be discharged into the vehicle through the first air flow path. The filtered air in the first air flow path may be heat-exchanged by the heat exchange module 112 and then discharged into the vehicle.

Also, the armrest apparatus 100 may include a second air flow path for suctioning in and then discharging at least one of the air inside the vehicle and the air supplied by the air conditioning unit of the vehicle into the vehicle. Blown air may be discharged into the vehicle through the second air flow path. The blown air in the second air flow path may be heat-exchanged by the heat exchange module 112 and then discharged into the vehicle. Here, when the blown air passes through the dust filter 108a of the air cleaning unit 108, wind pressure falls. Accordingly, the blown air becomes discharged into the vehicle through the second air flow path provided to avoid the air cleaning unit 108.

Meanwhile, in the above, the air cleaning function performed by the air cleaning unit 108 and the heat-exchanged air blowing function performed by the heat exchange module 112 have been described as being operated with the reservation function but are not limited thereto. The air cleaning function of discharging the filtered air of the first air flow path into the vehicle and the air blowing function of discharging the blown air of the second air flow path into the vehicle may be operated through the reservation function as described above.

A first fan which suctions the air inside the vehicle through the air inlet portion 106 may be provided at the first air flow path. The first fan may allow the suctioned air inside the vehicle to move toward the air cleaning unit 108 to be filtered and then discharged into the vehicle through the air outlet portion 110. Also, a second fan which suctions at least one of the air inside the vehicle and the air discharged by the air conditioning unit of the vehicle into the armrest apparatus 100 may be provided at the second air flow path. The second fan may discharge the suctioned air into the vehicle through the air outlet portion 110. However, not limited thereto, the air inside the vehicle may be suctioned into the air inlet portion 106 using the first fan and then may be discharged into the vehicle through the second air flow path (that is, without passing through the air cleaning unit 108). Also, the armrest apparatus 100 may include a single fan. In this case, the filtered air or the blown air may be discharged into the vehicle through the single fan. That is, the filtered air may be discharged into the vehicle through the first air flow path or the blown air may be discharged into the vehicle through the second air flow path using the single fan.

Also, the armrest apparatus 100 may include an air flow cushion portion (not shown) formed of felt or a mesh fabric structure, etc. The air flow cushion portion may be provided on a portion of the armrest apparatus 100 on which the user rests the user's body. For example, the air flow cushion portion may be provided at the cover portion 104. Here, the filtered air through the first air flow path or the blown air through the second air flow path may pass through the air flow cushion portion and may be discharged into the vehicle. Since the air flow cushion portion is formed of felt or a mesh fabric structure, etc., there is provided a path through which air moves. The air flow cushion portion may be provided while surrounding the cover portion 104. However, not limited thereto, the air flow cushion portion may be provided at a part of the cover portion 104.

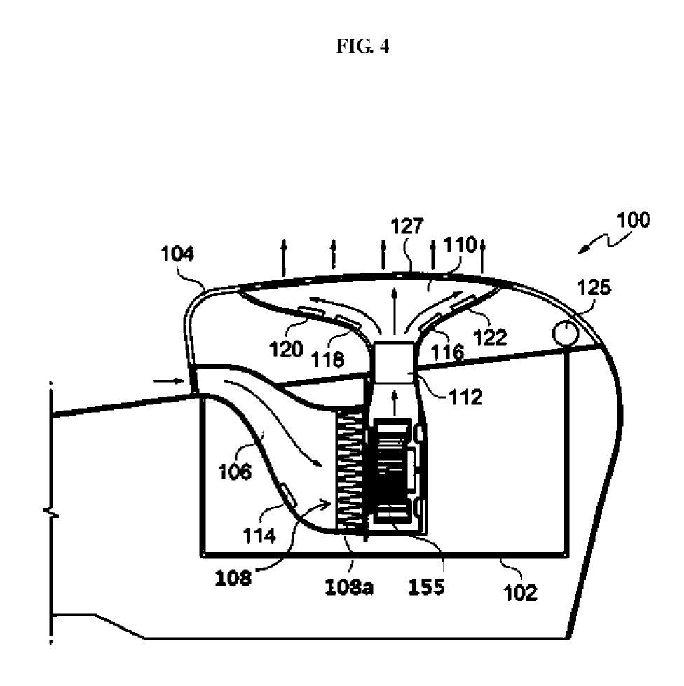

FIG. 4 is a cross-sectional view of an armrest apparatus for a vehicle according to a second embodiment of the present invention.

Referring to FIG. 4, the armrest apparatus 100 may include the storage portion 102, the cover portion 104, the air inlet portion 106, the air cleaning unit 108, the air outlet portion 110, the heat exchange module 112, an ultraviolet (UV) emitting portion 114, an ion generator 116, an air freshening device 118, a lighting portion 120, and an ozone generator 122.

The storage portion 102 is provided inside the armrest apparatus 100. The storage portion 102 includes a storage space for storing articles (for example, a water bottle, a can, a portable device, etc.). Here, the armrest apparatus 100 has been described as including the storage portion 102 but is not limited thereto and may not include the storage portion 102.

The cover portion 104 may be provided above the storage portion 102. The cover portion 104 may be provided to open and close a top portion of the storage portion 102. The cover portion 104 may become a portion on which a passenger in the vehicle rests a part of his or her body (for example, an arm, a hand, etc.). The cover portion 104 may be pivotably hinge-coupled with one side of the armrest apparatus 100 through a hinge 125. Here, the cover portion 104 may be hinge-coupled with an adjustable pivoting angle. For example, the cover portion 104 may be provided with the pivoting angle adjustable by a certain angle (for example, 10° or 30°, etc.). In this case, the cover portion 104 may pivot at an angle desired by the passenger of the vehicle and then may be fixed. However, the cover portion 104 is not limited thereto and may be slidably coupled with the armrest apparatus 100.

The air inlet portion 106 may allow air inside the vehicle to flow into the armrest apparatus 100. The air inlet portion 106 may allow the air inside the vehicle to flow to the air cleaning unit 108. One side of the air inlet portion 106 may be opened from the armrest apparatus 100 toward the inside of the vehicle. That is, the one side of the air inlet portion 106 may be connected to the inside of the vehicle at the armrest apparatus 100. The other side of the air inlet portion 106 may be connected to the air cleaning unit 108. The air inlet portion 106 includes a path through which air is movable. A cross section of the other side of the air inlet portion 106 may be provided to be larger than a cross section of the one side of the air inlet portion 106. For example, a cross section of the air inlet portion 106 may be provided to become larger as getting toward the other side of the air inlet portion 106 from the one side thereof. The air inlet portion 106 may be provided on a side of the storage portion 102 in the armrest apparatus 100.

The air cleaning unit 108 performs a function of purifying the air inside the vehicle which flows in through the air inlet portion 106. The air cleaning unit 108 may include the dust filter 108a. The dust filter 108a may be provided in the air inlet portion 106. The dust filter 108a may be provided in another end of the air inlet portion 106. The dust filter 108a may be provided to allow an adsorption surface to intersect with a moving direction of the air inside the vehicle in the air inlet portion 106. The dust filter 108a may be provided while occupying the entire path which intersects with the moving direction of the air inside the vehicle in the air inlet portion 106. In this case, all the air inside the vehicle which flows in the air inlet portion 106 is allowed to pass through the dust filter 108a. The dust filter 108a may be vertically provided in the air inlet portion 106 but is not limited thereto and may be provided to incline to extend a contact area with the air inside the vehicle. The dust filter 108a may filter out fine dust, yellow dust, foreign substances, etc. included in the air inside the vehicle to purify the air inside the vehicle. Here, the dust filter 108a has been described as being provided in the air inlet portion 106 but is not limited thereto and may be provided in an additional space connected to the other end of the air inlet portion 106.

The dust filter 108a may be accommodated in a dust filter cart (not shown). The dust filter cart may be provided on one side of the armrest apparatus 100 to be insertable and withdrawable. In this case, the dust filter 108a may be replaced by a new one after withdrawing the dust filter cart from the armrest apparatus 100. That is, the dust filter 108a may be provided to be replaceable through the dust filter cart. Here, the fan 155 may be provided on the other side of the dust filter 108a. That is, when the air inside the vehicle flows in one side of the dust filter 108a, the fan 155 may be provided on the other side of the dust filter 108a. The fan 155 may be provided on the side of the storage portion 102. The fan 155 may be provided in the air outlet portion 110.

The air outlet portion 110 may be provided in the armrest apparatus 100. One side of the air outlet portion 110 may be provided to be connected to the air cleaning unit 108 and the other side of the air outlet portion 110 may be provided to be connected to the inside of the vehicle. The air outlet portion 110 includes a path through which air is movable. The fan 155 may be accommodated in the one side of the air outlet portion 110. The other side of the air outlet portion 110 (that is, a portion through which the filtered air is discharged) may be provided at the cover portion 104. Here, at least one air hole 127 through which the filtered air is discharged may be provided at the other end of the air outlet portion 110 (that is, a surface of the cover portion 104). The air hole 127 may be provided in overall a certain area of the surface of the cover portion 104. The other side of the air outlet portion 110 may be provided to have a cross section which becomes larger as getting toward the surface of the cover portion 104 from an inside of the cover portion 104. For example, the other side of the air outlet portion 110 may be provided to have the cross section which becomes larger as getting toward the surface of the cover portion 104 from the inside of the cover portion 104 to correspond to the area in which the air hole 127 is provided.

As described above, when the filtered air is discharged into the vehicle through the cover portion 104 and the cover portion 104 is provided with an adjustable pivoting angle, an air blowing direction of the filtered air may be adjustable as a desired direction of the passenger by adjusting the pivoting angle of the cover portion 104. The one side of the air outlet portion 110 provided at a body of an armrest and the other side of the air outlet portion 110 provided at the cover portion 104 of the armrest may be provided to be fluidly connected. That is, when the cover portion 104 is closed, the one side and the other side of the air outlet portion 110 may be provided to be fluidly connected to each other.

Here, the air hole 127 may be provided at a top surface of the cover portion 104. That is, the air hole 127 may be provided at the top surface of the cover portion 104 with which a part of the body of the passenger is in general contact. In this case, the air outlet portion 110 discharges the filtered air into the vehicle at the top surface of the cover portion 104. However, the air outlet portion 110 is not limited thereto and may discharge the filtered air toward seats provided on both sides of the armrest apparatus 100. That is, the other side of the air outlet portion 110 may be connected to the inside of the vehicle at the both sides of the armrest apparatus 100. The other side of the air outlet portion 110 may be connected to the inside of the vehicle at both sides of the cover portion 104.

Mean while, the armrest apparatus 100 may further include a fan control portion (not shown) which allows the air outlet portion 110 to discharge the filtered air toward a seat in which the passenger sits among the seats provided on the both sides of the armrest apparatus 100 (for example, a driver's seat and a passenger seat). In detail, a seat-taking sensor which senses whether the passenger sits may be provided in each of the seats of the vehicle. The seat-taking sensor may generate a seat-taking signal toward the armrest apparatus 100 when the passenger sits in a seat. Then, the armrest apparatus 100 may allow the air outlet portion 110 to discharge the filtered air through the fan control portion only toward the seat in which the passenger sits.

For example, when the passenger sits only in the driver's seat while the other side of the air outlet portion 110 is opened toward each of the driver's seat and the passenger seat, the fan control portion may allow the filtered air to be discharged only toward the driver's seat by shielding an inside of the air outlet portion 110 provided to be opened toward the passenger seat and opening an inside of the air outlet portion 110 provided to be opened toward the driver's seat. Also, when the armrest apparatus 100 is provided on a side of a certain seat of the vehicle (for example, a side toward the door), the fan 155 may be operated depending on whether the passenger sits in the corresponding seat to discharge the filtered air to the corresponding seat.

The heat exchange module 112 may be provided in the air outlet portion 110. The heat exchange module 112 may heat-exchange air transferred inside the air outlet portion 110. For example, the heat exchange module 112 may cool or heat the air transferred inside the air outlet portion 110. In this case, cool air or warm air becomes discharged into the vehicle through the air outlet portion 110. The heat exchange module 112 may be provided on the other side of the air outlet portion 110 (that is, a portion through which the filtered air is discharged). When the other side of the air outlet portion 110 is provided at the cover portion 104, the heat exchange module 112 may be provided in the cover portion 104.

The UV emitting portion 114 may be provided in at least one of the air inlet portion 106 and the air outlet portion 110. The UV emitting portion 114 may emit UV rays toward a photocatalyst (not shown) provided on an inside (for example, an inner wall) of at least one of the air inlet portion 106 and the air outlet portion 110. The photocatalyst may be formed by coating an inner wall of at least one of the air inlet portion 106 and the air outlet portion 110 with at least one photocatalyst of titanium dioxide, zinc oxide, cadmium sulfide, and tungsten oxide. However, a kind of the photocatalyst is not limited thereto. When UV rays are emitted to the photocatalyst, the photocatalyst generates sterilizing materials such as hydroxy radical and super oxide which have strong oxidizing power. Hydroxy radical and super oxide described above oxidize and decompose contaminants in the air inside the vehicle to sterilize.

Here, the fan 155 may discharge the sterilizing material generated by the photocatalyst into the vehicle through the air outlet portion 110. The UV emitting portion 114 may sterilize the dust filter 108a by emitting the UV rays to the dust filter 108a. Here, the dust filter 108a may include a photocatalyst. In this case, a sterilizing material is generated by the photocatalyst of the dust filter 108a, thereby effectively sterilizing the dust filter 108a.

The ion generator 116 may generate at least one of negative ions and positive ions in at least of the air inlet portion 106 and the air outlet portion 110. The ion generator 116 may be provided in at least one of the air inlet portion 106 and the air outlet portion 110 but is not limited thereto and may be provided at another place inside the vehicle while being connected to the inside of at least one of the air inlet portion 106 and the air outlet portion 110. The ion generator 116 may operate in connection with a contamination degree inside the vehicle. For example, the ion generator 116 may be embodied to operate when the contamination degree inside the vehicle exceeds a reference value. Also, the ion generator 116 may control an ion generation amount or ion concentration according to the contamination degree inside the vehicle. The ions generated by the ion generator 116 may be discharged into the vehicle through the air outlet portion 110.

The air freshening device 118 may generate an aroma in at least one of the air inlet portion 106 and the air outlet portion 110. The air freshening device 118 may be provided in at least one of the air inlet portion 106 and the air outlet portion 110 but is not limited thereto and may be provided at another place inside the vehicle while being connected to the inside of at least one of the air inlet portion 106 and the air outlet portion 110. The air freshening device 118 may include a plurality of air fresheners. The air freshening device 118 may generate any one aroma according to a selection of the passenger in the vehicle. Here, the armrest apparatus 100 may include an input portion (not shown) for receiving a command of the passenger. The aroma generated by the air freshening device 118 may be discharged into the vehicle through the air outlet portion 110.

The lighting portion 120 may be provided inside the air outlet portion 110. The lighting portion 120 may emit light through the other end of the air outlet portion 110 (that is, a place connected to the inside of the vehicle). For example, the lighting portion 120 may emit light through the air hole 127 provided in the cover portion 104. In this case, the filtered air is discharged and the light is emitted through the air hole 127, thereby providing a romantic lighting mood. Meanwhile, when cool air or warm air is discharged through the air hole 127, the lighting portion 120 may be provided to allow a color temperature to be adjusted according to a temperature of the air discharged through the air outlet portion 110. For example, when the cool air is discharged through the air outlet portion 110, the lighting portion 120 may be adjusted as a cool color temperature (for example, 5,000 K to 7,000 K). For example, when the warm air is discharged through the air outlet portion 110, the lighting portion 120 may be adjusted as a warm color temperature (for example, 1,000K to 3,000K). Also, the lighting portion 120 may be provided to be changed in color temperature according to a change in a temperature inside the air outlet portion 110.

Also, the lighting portion 120 may provide information related to the filtered air of the first air flow path and the blown air of the second air flow path. For example, information such as whether the filtered air and the blown air are discharged into the vehicle (that is, whether the air cleaning function and the air blowing function are operated) and the intensities or temperatures of the filtered air and the blown air when the filtered air and the blown air are discharged may be provided. The lighting portion 120 may provide information related to the filtered air of the first air flow path and the blown air of the second air flow path through a change in lighting color, a change in brightness of a lighting, a change in color temperature of the lighting, etc. The lighting portion 120 may be provided by arranging light emitting diodes (LED) in a row on the armrest. Here, when the filtered air and the blown air are discharged into the vehicle, the LEDs arranged in the row are sequentially turned on (or sequentially flicker) to notify whether the filtered air and the blown air are discharged.

The ozone generator 122 may generate ozone in at least one of the air inlet portion 106 and the air outlet portion 110. The ozone generator 122 may be provided in at least one of the air inlet portion 106 and the air outlet portion 110 but is not limited thereto and may be provided at another place inside the vehicle while being connected to the inside of at least one of the air inlet portion 106 and the air outlet portion 110. The ozone generator 122 may operate in connection with a contamination degree inside the vehicle. For example, the ozone generator 122 may be embodied to operate when the contamination degree inside the vehicle exceeds a reference value. Also, the ozone generator 122 may control an ozone generation amount or ozone concentration according to the contamination degree inside the vehicle. The ozone generated by the ozone generator 122 may be discharged into the vehicle through the air outlet portion 110.

According to embodiments of the present invention, the air inside the vehicle is suctioned into the armrest apparatus 100 and filtered and discharged, thereby purifying the air inside the vehicle through the armrest apparatus 100. Since the armrest apparatus 100 is mounted at a position adjacent to a passenger such as being in contact with a part of the body of the passenger, it is possible to make air around the passenger fresh through the armrest apparatus 100. Here, ions and ozone are discharged together with filtered air, thereby sterilizing the inside of the vehicle. Also, since the armrest apparatus 100 includes the heat exchange module 112, the armrest apparatus 100 may autonomously discharge cool air or warm air into the vehicle independent of the air conditioning apparatus of the vehicle.

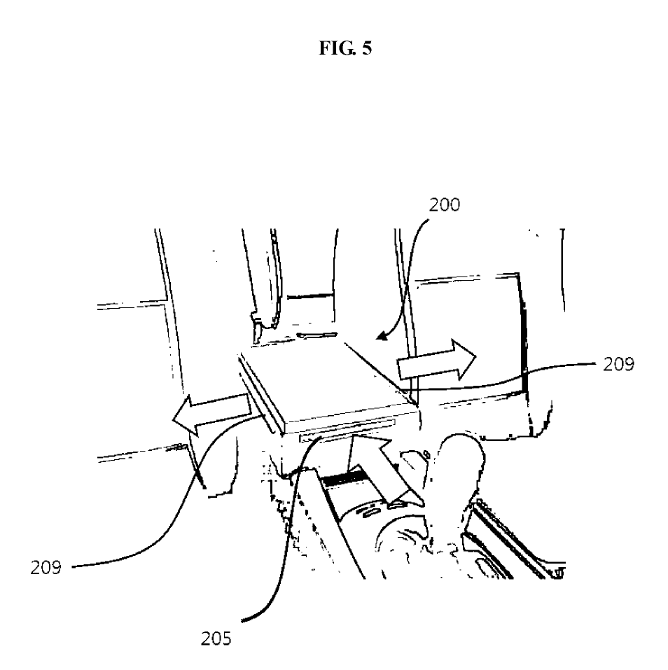

FIG. 5 is a view illustrating a state of suctioning and then discharging air at the armrest apparatus according to the embodiment of the present invention.

Referring to FIG. 5, the armrest apparatus 100 may be a center console. The air inlet portion 106 may suction the air inside the vehicle in front of the armrest apparatus 100. The air outlet portion 110 may discharge the filtered air toward the seats provided on both sides of the armrest apparatus 100 (that is, toward the passenger).

Here, the air inlet portion 106 is shown as suctioning the air inside the vehicle in front of the armrest apparatus 100 but is not limited thereto and may suction the air inside the vehicle from at least one of a front, a rear, and sides of the armrest apparatus 100. Also, here, the air outlet portion 110 is shown as discharging the filtered air toward the both sides of the armrest apparatus 100 but is not limited thereto and may discharge the filtered air in a direction of at least one of a front, a rear, sides, and a top of the armrest apparatus 100.

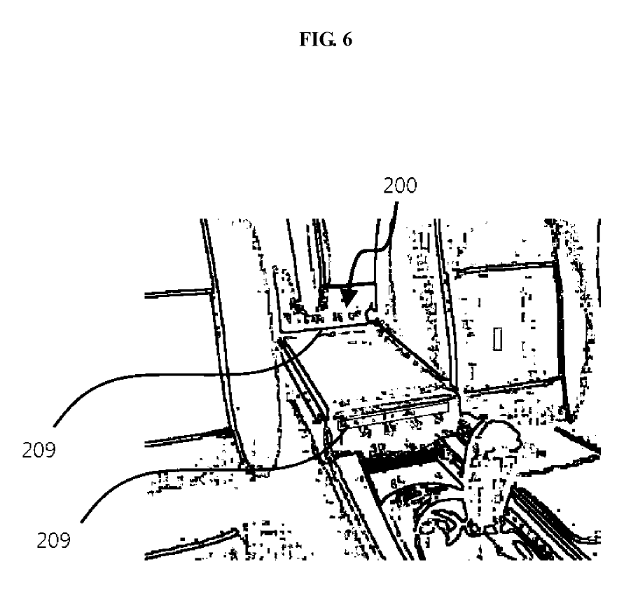

FIG. 6 is a view illustrating a state of discharging ions from the armrest apparatus for the vehicle according to the embodiment of the present invention.

Referring to FIG. 6, the air outlet portion 110 may discharge negative ions and positive ions generated by the ion generator 116 forward and backward from the armrest apparatus 100. However, not limited thereto, the air outlet portion 110 may discharge negative ions and positive ions in at least one of directions of the front, rear, sides, and top of the armrest apparatus 100.

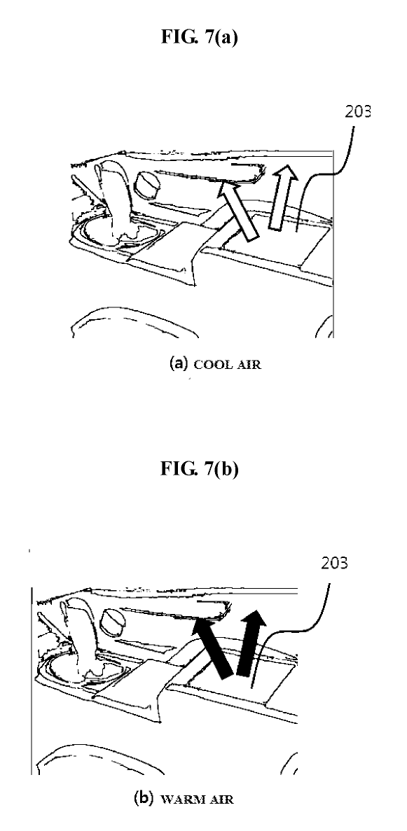

FIG. 7 is a view illustrating a state of illuminating by the armrest apparatus for the vehicle according to the embodiment of the present invention.

Referring to FIG. 7, when cool air is discharged through the air hole 127 of the cover portion 104, the lighting portion 120 may be adjusted as a cool color temperature (for example, 5,000 K to 7,000 K, refer to FIG. 7(a)). Also, when warm air is discharged through the air hole 127 of the cover portion 104, the lighting portion 120 may be adjusted as a warm color temperature (for example, 1,000K to 3,000K, refer to FIG. 7(b)). Light generated by the lighting portion 120 becomes emitted into the vehicle through the air hole 127. Here, since the light generated by the lighting portion 120 has a color matched with the cool air or the warm air discharged through the air hole 127, the passenger may visually know whether it is the cool air or the warm air and a special lighting mood may be provided.

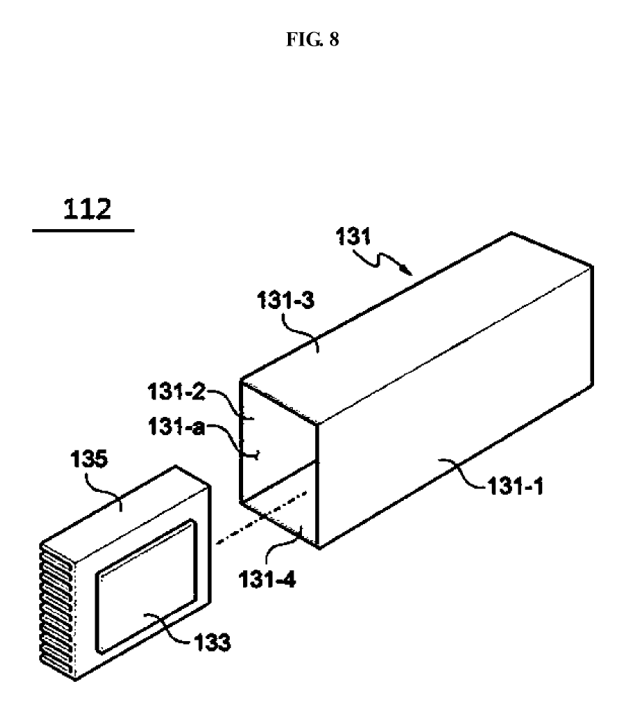

FIG. 8 is a schematic diagram illustrating an example of the heat exchange module in the armrest apparatus for the vehicle according to the embodiment of the present invention.

Referring to FIG. 8, the heat exchange module 112 may include a case 131, a thermoelectric element 133, and a heat exchange portion 135.

The case 131 includes an accommodating space 131-a therein. The case 131, for example, may be formed in a hollow square pillar shape. However, the shape of the case 131 is not limited thereto. Hereinafter, a case in which the case 131 has the hollow square pillar shape will be described as an example. The case 131 may include a front plate 131-1, a rear plate 131-2 formed opposite the front plate 131-1 behind the front plate 131-1, a top plate 131-3 formed while connecting top ends of the front plate 131-1 and the rear plate 131-2, and a bottom plate 131-4 formed while connecting bottom ends of the front plate 131-1 and the rear plate 131-2. The case 131 may be formed of a material with high thermal conductivity. For example, the case 131 may include aluminum, magnesium, stainless steel, an aluminum alloy, copper, etc. The case 131 may be manufactured by extrusion molding. The entire or a part of the case 131 may be surface-treated for improving heat dissipation. The case 131 may be fixedly mounted in the air outlet portion 110. For example, the case 131 may be inserted into and coupled to the inner wall of the air outlet portion 110.

The thermoelectric element 133 may be accommodated in and fixed to the accommodating space 131a of the case 131. The thermoelectric element 133 may cool or heat the heat exchange portion 135. In this case, the air which passes through the case 131 may be cooled or heated. A heating portion (for example, a thin metal heater, a hot wire, etc.) may be provided instead of the thermoelectric element 133.

The heat exchange portion 135 and the thermoelectric element 133 may be accommodated together in the accommodating space 131-a of the case 131. The heat exchange portion 135 may be in contact with one side of the thermoelectric element 133. The heat exchange portion 135 may be cooled or heated by the thermoelectric element 133. The heat exchange portion 135 may be formed by arranging a plurality of heat exchange pins 135-1 spaced apart from each other. The heat exchange portion 135 may be formed of a material with high thermal conductivity.

Here, a surface of at least one of the case 131, the thermoelectric element 133, and the heat exchange portion 135 may be treated with a material including at least one of alumina, magnesium oxide, sodium oxide, zirconium oxide, potassium oxide, graphene, and carbon nano tubes (CNT). In this case, heat generated by the thermoelectric element 133 may change in wavelength to far infrared rays at a portion surface-treated with the material, thereby improving thermal efficiency and well transferring the heat generated by the thermoelectric element 133 in a long distance.

Meanwhile, the heat exchange module 112 may further include an overheating-preventing portion (not shown) to prevent the heat exchange portion 135 from excessively increasing in a temperature. For example, the overheating-preventing portion may measure a temperature of the heat exchange portion 135 and may block off an operation of the thermoelectric element 133 when the temperature increases higher than a preset temperature.

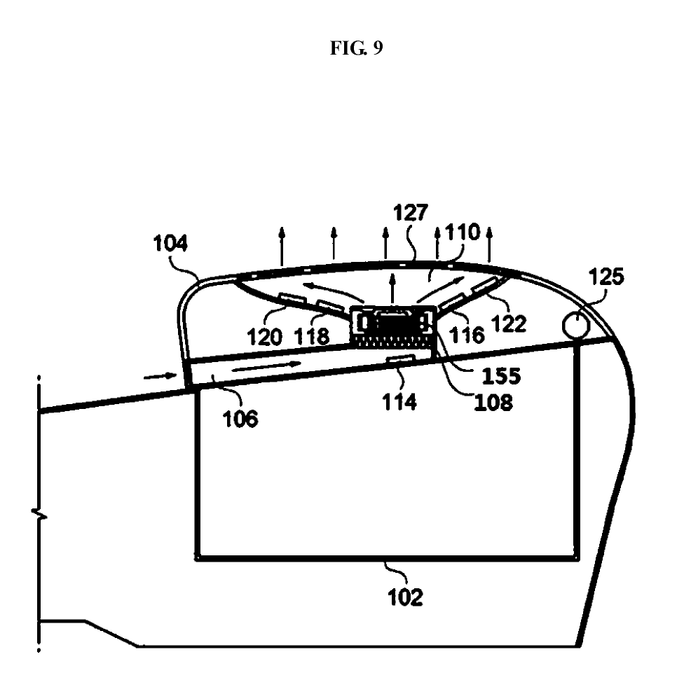

FIG. 9 is a cross-sectional view of an armrest apparatus for a vehicle according to a third embodiment of the present invention. Here, differences from the second embodiment shown in FIG. 4 will be mainly described.

Referring to FIG. 9, the air inlet portion 106 may be provided in the cover portion 104. The one side of the air inlet portion 106 may be connected to the inside of the vehicle in front of the cover portion 104. The air cleaning unit 108 may be provided at the other side of the air inlet portion 106. The air cleaning unit 108 may be provided in the cover portion 104. Also, the air outlet portion 110 may also be provided in the cover portion 104. Although not shown in FIG. 9, the heat exchange module 112 may also be provided inside the air outlet portion 110 in the cover portion 104. As described above, components such as the air inlet portion 106, the air cleaning unit 108, the air outlet portion 110, the heat exchange module 112, the UV emitting portion 114, the ion generator 116, the air freshening device 118, the lighting portion 120, etc. may be modularized at the cover portion 104 of the armrest apparatus 100.

Meanwhile, the dust filter 108a of the air cleaning unit 108 may be provided at the cover portion 104 and the fan 155 may be provided at the body of the armrest. Here, an air flow connecting portion (not shown) which fluidly connects the dust filter 108a and the fan 155 may be provided between the cover portion 104 and the body of the armrest. The air flow connecting portion may be provided at a portion at which the cover portion 104 and the body of the armrest are hinge-coupled.

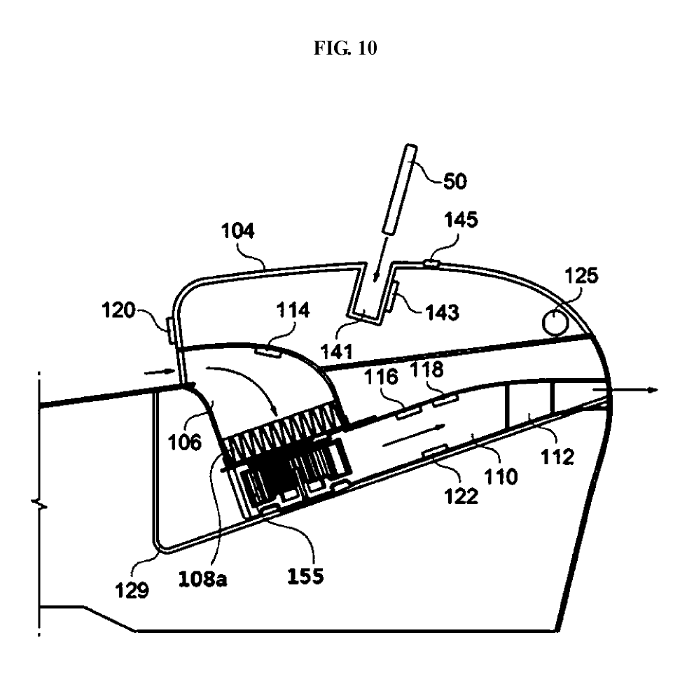

FIG. 10 is a cross-sectional view of an armrest apparatus for a vehicle according to a fourth embodiment of the present invention. Here, differences from the second embodiment shown in FIG. 4 will be mainly described.

Referring to FIG. 10, the air inlet portion 106 may suction air inside the vehicle at a front of the armrest apparatus 100. That is, one end of the air inlet portion 106 may be connected to the inside of the vehicle in front of the armrest apparatus 100. The dust filter 108a may be mounted on and accommodated in the other end of the air inlet portion 106. The air outlet portion 110 may be provided inside the armrest apparatus 100 toward the rear of the armrest apparatus 100. The fan 155 may be accommodated in the one side of the air outlet portion 110. The other end of the air outlet portion 110 may be connected to the inside of the vehicle at the rear of the armrest apparatus 100. The air outlet portion 110 may be provided inside the armrest apparatus 100 to incline toward an upper portion. A supporting portion 129 may be provided at a bottom of the air outlet portion 110. The supporting portion 129 supports the air inlet portion 106, the air cleaning unit 108, and the air outlet portion 110 inside the armrest apparatus 100.

As described above, the air inlet portion 106 is provided to be connected to the inside of the vehicle at the front of the armrest apparatus 100 and the air outlet portion 110 is provided to be connected to the inside of the vehicle at the rear of the armrest apparatus 100, thereby suctioning and filtering the air inside the vehicle at the front of the armrest apparatus 100 and then discharging the filtered air toward the rear of the armrest apparatus 100. However, not limited thereto, the air inside the vehicle may be suctioned and filtered at the front (or the rear) of the armrest apparatus 100 and then may be discharged toward the front (or the rear) of the armrest apparatus 100.

Meanwhile, the cover portion 104 may include a portable device accommodating groove 141 in which the entire or a part of a portable device 50 is inserted and accommodated. The portable device 50, for example, may be a smart phone, a mobile phone, personal digital assistants (PDA), an MP3, a tablet personal computer (PC), a portable multimedia player (PMP), etc. but is not limited thereto and various portable devices may be applied. An accommodating space of the portable device accommodating groove 141 may perform a function of a sound box. The accommodating space of the portable device accommodating groove 141 may have a size as large as sound pressure generated by the portable device 50 increases. For example, the accommodating space of the portable device accommodating groove 141 may be formed two times larger than the portable device 50. In this case, sounds such as an incoming call ringtone, an incoming message ringtone, etc. of the portable device 50 are amplified at the portable device accommodating groove 141 to more surely notify an incoming state of the portable device 50 to a user. To allow a passenger to see a part of a screen of the portable device 50 accommodated in the portable device accommodating groove 141, the portable device accommodating groove 141 may be formed to incline at a certain angle with the cover portion 104. To protect the portable device 50 from an external shock, an inner wall of the portable device accommodating groove 141 may include an elastic material (for example, rubber, urethane, etc.).

Also, a position fixing portion (not shown) which pressurizes and fixes the portable device 50 may be provided inside the portable device accommodating groove 141. The position fixing portion may fix the portable device 50 at a certain position while pressurizing the portable device 50 toward a wireless charging portion 143. The position fixing portion may be provided while protruding from the inner wall of the portable device accommodating groove 141 and may include an elastic member.

The wireless charging portion 143 may be provided on one side of the portable device accommodating groove 141. The wireless charging portion 143 may wirelessly charge the portable device 50 accommodated in the portable device accommodating groove 141. The wireless charging portion 143 includes a power transmitting portion which charges a battery of the portable device 50 by emitting wireless power into the air. The power transmitting portion, for example, may be a charging coil, an emitter, etc. Also, the wireless charging portion 143 may include a charging control portion which controls power emission of the power transmitting portion.

The cover portion 104 may include a wired connecting portion 145. The wired connecting portion 145 may be connected to the portable device 50 through wires through a cable (for example, a data cable, a charging cable, a data and charging cable, etc.). The portable device 50 may be charged through wires using the wired connecting portion 145. The portable device 50 may be charged wirelessly or through wires using the wireless charging portion 143 and the wired connecting portion 145.

Meanwhile, the heat exchange module 108 may include a heater portion (for example, a thin film heater, etc.) and the armrest may include a hot wire heater. Here, the hot wire heater may be provided at a portion of the armrest with which a body of a user is in contact (for example, the cover portion 104). The heater portion of the heat exchange module 108 heat-exchanges air which flows in the armrest. Also, the air heat-exchanged at the heat exchange module 108 (that is, warm air) is discharged into the vehicle. Here, the heat exchange module 108 and the hot wire heater may be operated in parallel in a preset condition. For example, when a temperature inside the vehicle is less than a preset temperature, the heat exchange module 108 and the hot wire heater may be operated in parallel. That is, the heat exchange module 108 is operated to discharge warm air into the vehicle and the hot wire heater is operated to heat the portion in contact with the body of the user. When the temperature inside the vehicle drops to −5° C. or less, the heat exchange module 108 and the hot wire heater are operated in parallel, thereby minimizing inconvenience to the user caused by cold.

The heat exchange module 108 and the hot wire heater may be reserved to be operated in parallel before sensing whether the user gets in or in connection with the sensing whether the user gets in when the temperature inside the vehicle (or a temperature outside the vehicle) is less than the preset temperature. When a preset time passes after the heat exchange module 108 and the hot wire heater are operated in parallel or the temperature inside the vehicle becomes the preset temperature or more, it may be reserved that one of the heat exchange module 108 and the hot wire heater is turned off and the other keeps being operated.

The armrest apparatus 100 may include an operation switch portion (not shown) which allows the user to operate the armrest apparatus 100. The user may operate the armrest apparatus 100 to perform a certain function using the operation switch portion. The operation switch portion may be embodied as a button type or a touch panel type.

Here, the armrest apparatus for the vehicle to be applied to the armrest in the vehicle has been described but the present invention is not limited thereto and may be applied to structures inside the vehicle such as a seat, a headrest, an overhead console, a handle, a door, etc. mounted in the vehicle.

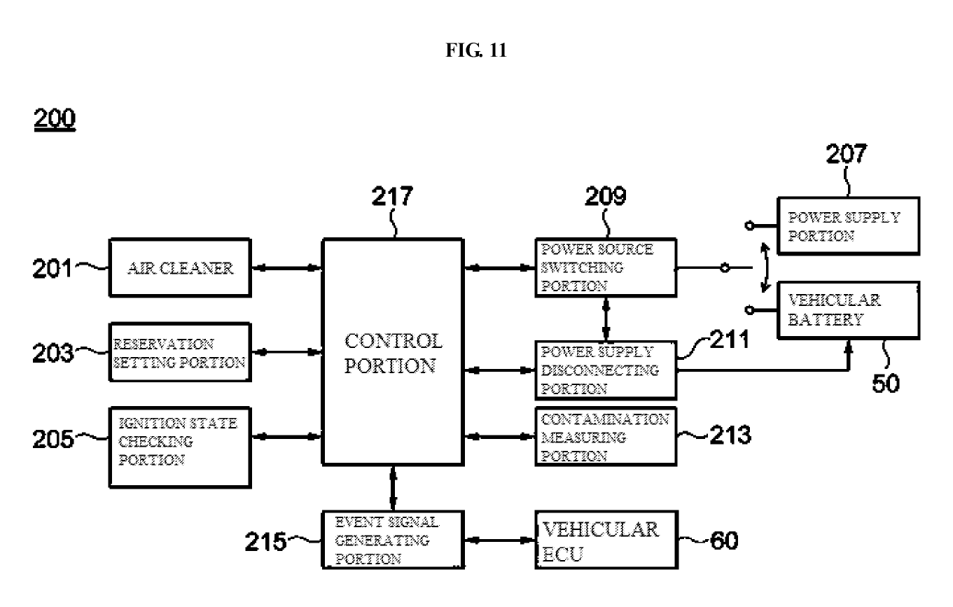

FIG. 11 is a block diagram illustrating components of the air cleaning apparatus according to the embodiment of the present invention.

Referring to FIG. 11, an air cleaning apparatus 200 for a vehicle may include an air cleaner 201, a reservation setting portion 203, an ignition state checking portion 205, a power supply portion 207, a power source switching portion 209, a power supply disconnecting portion 211, a contamination measuring portion 213, an event signal generating portion 215, and a control portion 217.

The air cleaner 201 may be mounted inside the vehicle. The air cleaner 201, for example, may be provided at an overhead console inside the vehicle but is not limited thereto and may be provided at various structures (for example, a center fascia, a dashboard, a rear seat hood, an armrest, a center console, a vehicular door, a headrest, etc.). The air cleaner 201 may generate and send ions into the vehicle. The air cleaner 201 may suction and filter the air inside the vehicle and then may send the filtered air into the vehicle again. The air cleaner 201 may generate and send a sterilizing material into the vehicle. The air cleaner 201 may generate and send an aroma into the vehicle.

The reservation setting portion 203 may receive reservation information including at least one of operation starting information and operation time information of the air cleaner 201 and may reserve an operation of the air cleaner 201 according to the reservation information. The reservation setting portion 203 may receive the reservation information from a user or a manager through a user interface provided in the vehicle (for example, a navigation device, etc.). However, not limited thereto, the air cleaning apparatus 200 may include an additional user interface. Also, the reservation setting portion 203 may include a communication means which communicates with a user terminal and may receive reservation information from the user terminal.

Here, the operation starting information of the air cleaner 201 may include information on a time or a point in time at which the air cleaner 201 starts operation (that is, an operation starting time). The operation time information of the air cleaner 201 may include information on time during which the operation of the air cleaner 201 starts and then remains operating. The operation starting time of the air cleaner 201 may be set as a certain time before the user gets in the vehicle. For example, when the user plans to get in the vehicle at 9 am, the operation starting time of the air cleaner 201 may be set as 8:30 am. Then, the air cleaner 201 is operated in advance before the user gets in the vehicle to purify the air inside the vehicle.

An operation starting point in time of the air cleaner 201 may be a point in time of unlocking a door of the vehicle, a point in time of sensing a smart key of the vehicle, a point in time of switching off the ignition of the vehicle, etc. That is, the air cleaner 201 may be allowed to operate at a point in time when the user generates a signal for unlocking the door through a key of the vehicle (for example, a smart key, etc.) near the vehicle. Also, when the user arrives near the vehicle while carrying a smart key, the air cleaner 201 may be allowed to operate at a point in time when the smart key responds to a wakeup signal sent by the vehicle. Also, the air cleaner 201 may be allowed to operate at a point in time when the ignition of the vehicle is turned off. However, not limited thereto, the air cleaner 201 may be allowed to operate when a preset time passes after the ignition of the vehicle is turned off. Also, after the ignition of the vehicle is turned off, the air cleaner 201 may periodically operate during an operation time of the reservation information.

The ignition state checking portion 205 may check an ignition state of the vehicle. The ignition state checking portion 205 may check whether the ignition of the vehicle is turned on or off. Here, a case that the ignition of the vehicle is turned on may include at least one of a case that a key is inserted in a key insertion portion (not shown) of the vehicle and in a LOCK state, a case that the inserted key is in an ACC state, a case that the inserted key is in an IGN (or ON) state, and a case that the inserted key is in a START state. Generally, the LOCK state refers to a position where the key of the vehicle is inserted into or withdrawn from and generally refers to a state in which a steering wheel is locked. The ACC state refers to a state in which power is supplied to accessory electronic components of the vehicle (for example, an audio system, a cigar jack, etc.). The IGN (or ON) state refers to a state in which power is supplied throughout the electronic system of the vehicle. The START state refers to a state in which the engine of the vehicle starts. However, not limited thereto, it may be differently set depending on vehicles or manufacturers. Also, a case that the ignition of the vehicle is turned off may include a case that the key of the vehicle is not inserted in the key insertion portion of the vehicle.

Meanwhile, in the case of a smart key, a case that the ignition of the vehicle is turned on may include at least one of cases of the LOCK state, the ACC state, the IGN (or ON) state, and the START state in relation to the ignition of the vehicle even though the smart key is not inserted. Also, a case that the ignition of the vehicle is turned off may include a case that the vehicle can not sense the smart key.

The ignition state checking portion 205, for example, may check an ignition state of the vehicle according to a signal generated at the key insertion portion of the vehicle (or a signal not generated). The ignition state checking portion 205 may check an ignition state of the vehicle between the operation starting time of the air cleaner 201 and an operation completion time of the air cleaner 201 according to the reservation information under the control of the control portion 217. The ignition state checking portion 205 may check the ignition state of the vehicle and may transmit ignition state information of the vehicle to the control portion 217.

The power supply portion 207 supplies power to the air cleaning apparatus 200 for the vehicle. The power supply portion 207 is an additional power supply means separate from a vehicular battery 50 for the vehicle mounted in the vehicle. That is, the power supply portion 207 is an autonomous power supply means for allowing the air cleaning apparatus 200 to autonomously receive power. The power supply portion 207 may include a photoelectric cell (not shown) which converts light energy into electric energy and a charging portion (not shown) which stores the electric energy obtained by the photoelectric cell. The power supply portion 207 may be charged by sunlight, light generated by a lamp inside the vehicle, etc.

The power source switching portion 209 may be electrically connected to one of the power supply portion 207 and the vehicular battery 50 depending on whether the ignition of the vehicle is turned on. For example, the power source switching portion 209 may be switched to be electrically connected to the vehicular battery 50 when the ignition of the vehicle is turned on. In this case, the air cleaning apparatus 200 may receive power supplied from the vehicular battery 50. Here, the power supply portion 207 may operate in a charging mode. Also, the power source switching portion 209 may be switched to be electrically connected to the power supply portion 207 when the ignition of the vehicle is turned off. In this case, the air cleaning apparatus 200 may receive power supplied from the power supply portion 207. The air cleaning apparatus 200 operates using autonomous power even when the ignition of the vehicle is turned off. The power source switching portion 209 may check whether the ignition of the vehicle is turned on from the vehicle ignition state information of the ignition state checking portion 205.

The power supply disconnecting portion 211 prevents the vehicular battery 50 from being discharged. When the power source switching portion 209 is electrically connected to the vehicular battery 50 while the ignition of the vehicle is turned on, the air cleaning apparatus 200 receives power from the vehicular battery 50. Here, when the power supply disconnecting portion 211 monitors a voltage of the vehicular battery 50 and the voltage of the vehicular battery 50 becomes a preset voltage or less, power supply from the vehicular battery 50 is cut off to prevent the vehicular battery 50 from being discharged.

The contamination measuring portion 213 may measure a contamination degree inside the vehicle. The contamination measuring portion 213 may transmit vehicle inside contamination information to the control portion 217. The contamination measuring portion 213 may measure the contamination degree inside the vehicle periodically or in real time but is not limited thereto and may measure the contamination degree inside the vehicle at a certain point in time under the control of the control portion 217. For example, the contamination measuring portion 213 may measure the contamination degree inside the vehicle at a point in time of starting an operation of the air cleaner 201 under the control of the control portion 217. However, not limited thereto, the contamination measuring portion 213 may measure the contamination degree inside the vehicle between the operation starting time of the air cleaner 201 and the operation completion time of the air cleaner 201 according to the reservation information under the control of the control portion 217.

The event signal generating portion 215 may generate an event signal to the control portion 217 when a preset event occurs. Here, the preset event, for example, may be a case that the ignition of the vehicle is turned on, a case that the ignition of the vehicle is turned off, a case that the door of the vehicle is unlocked, a case that the vehicle senses the smart key, etc. The event signal generating portion 215 may communicate with an electronic control unit (ECU) 60 of the vehicle to check whether the preset event occurs. That is, the event signal generating portion 215 may obtain information on whether the preset event occurs from the ECU 60. The event signal generating portion 215 may generate an event signal including event type information to the control portion 217. The event type information refers to information for distinguishing the event which occurs (for example, the case that the ignition of the vehicle is turned on, the case that the ignition of the vehicle is turned off, the case that the door of the vehicle is unlocked, the case that the vehicle senses the smart key, etc.).

The control portion 217 may control each of components of the air cleaning apparatus 200. In detail, the control portion 217 may receive the reservation information from the user, the manager, etc. and may control the reservation setting portion 203 to perform reservation settings of the air cleaner 201. The control portion 217 may control the operation of the air cleaner 201 according to reservation information including at least one of operation starting information and operation time information of the air cleaner 201. That is, the control portion 217 may operate the air cleaner 201 at an operation starting time or an operation starting point in time included in the operation starting information of the air cleaner 201 during an operation maintenance time included in the operation time information of the air cleaner 201.

The control portion 217 may control the contamination measuring portion 213 to measure the contamination degree inside the vehicle when the air cleaner 201 is operated according to the reservation information. The control portion 217 may generate a contamination measuring starting signal at the operation starting point in time of the air cleaner 201 to the contamination measuring portion 213. The control portion 217 may change the operation time information of the air cleaner 201 (that is, the operation maintenance time) among the reservation information depending on the contamination degree inside the vehicle measured by the contamination measuring portion 213. The control portion 217 may reduce or increase the operation maintenance time of the air cleaner 201 depending on a correlation between the contamination degree inside the vehicle and the operation maintenance time of the air cleaner 201 according to the reservation information. The correlation between the contamination degree inside the vehicle and the operation maintenance time of the air cleaner 201 according to the reservation information refers to a degree how much the contamination degree inside the vehicle approaches a preset reference value when the air cleaner 201 is operated during the operation maintenance time according to the reservation information. Here, the control portion 217 has been described as generating the contamination measuring starting signal at the operation starting point in time of the air cleaner 201 but is not limited thereto and may generate the contamination measuring starting signal between the operation starting time of the air cleaner 201 and the operation completion time of the air cleaner 201. In this case, the control portion 217 may change the operation maintenance time of the air cleaner 201 which remains from the contamination measuring point in time depending on a correlation between the residual operation maintenance time and the contamination degree inside the vehicle.

The control portion 217 may control the power source switching portion 209 to be electrically connected to one of the power supply portion 207 and the vehicular battery 50 depending on whether the ignition of the vehicle is turned on. For example, while the air cleaner 201 is operated according to the reservation information, the control portion 217 may obtain the vehicle ignition state information from the ignition state checking portion 205 periodically (or in real time) and may control the power source switching portion 209 to be electrically connected to one of the power supply portion 207 and the vehicular battery 50 depending on the obtained vehicle ignition state information. The control portion 217 may prevent the vehicular battery 50 from being discharged by controlling the power supply disconnecting portion 211 when the power source switching portion 209 is electrically connected to the vehicular battery 50.

The control portion 217 may operate the air cleaner 201 according to the occurrence of an event signal corresponding to the operation starting point in time of the air cleaner 201 among the reservation information. For example, when the operation starting point in time of the air cleaner 201 is a door unlocking point in time of the vehicle among the reservation information, the event signal generating portion 215 may check whether an event related to unlocking the door of the vehicle occurs from the ECU 60. When the event related to unlocking the door of the vehicle occurs, the event signal generating portion 215 generates an event signal to the control portion 217 and the control portion 217 operates the air cleaner 201. Here, the event signal generating portion 215 has been described as checking whether the event occurs from the ECU 60 but is not limited thereto and the control portion 217 may check whether the event occurs from the ECU 60. Also, even when the operation starting point in time of the air cleaner 201 among the reservation information is a point in time of sensing a smart key of the vehicle or a point in time of turning off the ignition of the vehicle, the control portion 217 may operate the air cleaner 201 depending on the occurrence of an event signal (or the occurrence of an event) corresponding thereto.

After operating the air cleaner 201 according to the reservation information, the control portion 217 may determine whether to maintain the operation of the air cleaner 201 depending on whether the event signal occurs during a preset time between the operation starting point in time of the air cleaner 201 and the operation completion time of the air cleaner 201 (that is, the operation completion time according to the operation maintenance time of the reservation information). Here, the event signal generating portion 215 may generate the event signal to the control portion 217, for example, in the case that the ignition of the vehicle is turned on, the case that the door of the vehicle is unlocked, the case that the vehicle senses the smart key, etc. When the event signal occurs during the preset time between the operation starting point in time of the air cleaner 201 and the operation completion time of the air cleaner 201, the control portion 217 may continuously maintain the operation of the air cleaner 201 till the operation completion time. That is, when the event signal occurs during the preset time between the operation starting point in time of the air cleaner 201 and the operation completion time of the air cleaner 201, since the user gets or is expected to get in the vehicle, the air cleaner 201 is continuously operated. When the event signal does not occur during the preset time between the operation starting point in time of the air cleaner 201 and the operation completion time of the air cleaner 201, the control portion 217 may stop the operation of the air cleaner 201 even though the operation completion time of the air cleaner 201 is not reached. That is, when the event signal does not occur during the preset time between the operation starting point in time of the air cleaner 201 and the operation completion time of the air cleaner 201, it is determined that the air cleaner 201 is reserved to operate in advance before the user gets in the vehicle but the user does not get in the vehicle due to a reason of the user. Accordingly, the operation of the air cleaner 201 is stopped.

According to the embodiment of the present invention, the air cleaner 201 is previously operated before the user gets in the vehicle, thereby providing a pleasant state of the air inside the vehicle when the user gets in the vehicle. Also, the air cleaning apparatus 200 includes an autonomous power source supply means, thereby operating to purify the air inside the vehicle while the ignition of the vehicle is turned off.

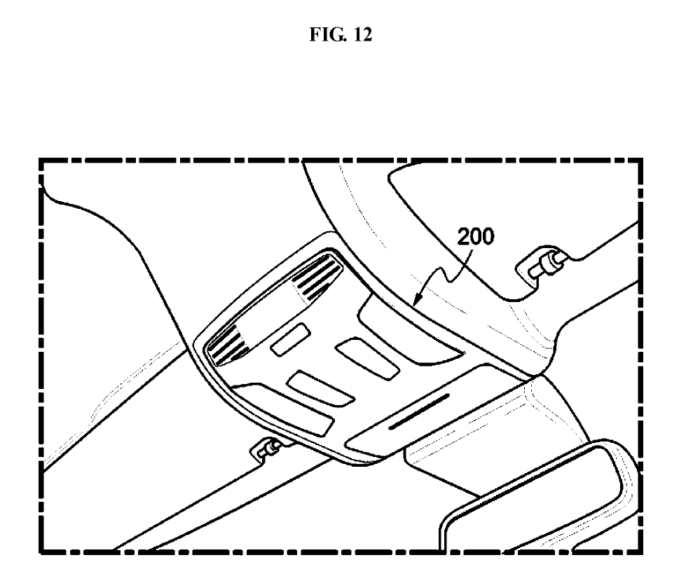

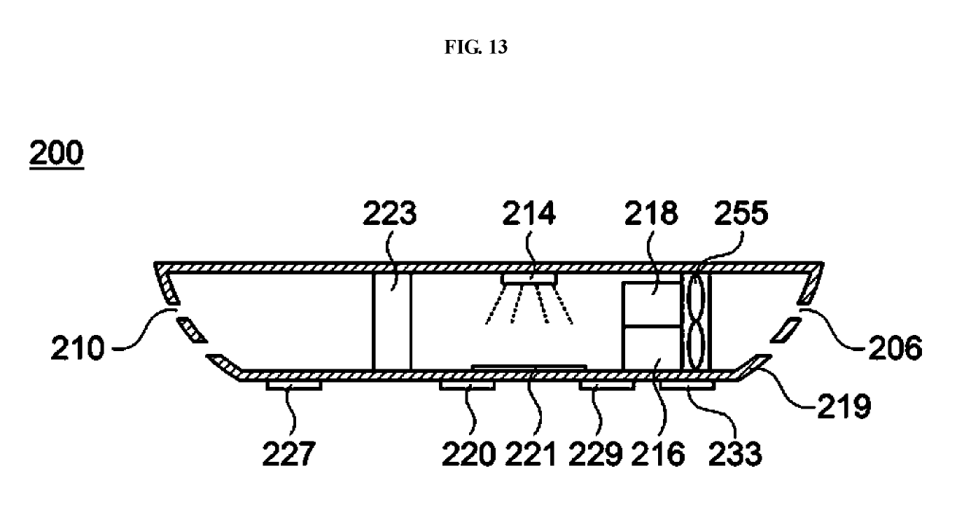

FIG. 12 is a view illustrating a state in which an air cleaning apparatus for a vehicle according to one embodiment of the present invention is applied to an overhead console, and FIG. 13 is a schematic diagram illustrating an overhead console apparatus according to one embodiment of the present invention. Here, a case that the air cleaning apparatus is provided at the overhead console is described as an example. However, not limited thereto, the air cleaning apparatus for the vehicle may be provided at various structures (for example, a center fascia, a dashboard, a rear seat hood, an armrest, a center console, a door, a handle, a headrest, etc.) inside the vehicle in addition thereto.

Referring to FIGS. 12 and 13, an overhead console apparatus 200 may include a housing portion 219, an ion generator 216, an air freshening device 218, a fan 255, an UV emitting portion 214, a photocatalyst portion 221, a dust filter 223, a notification portion 227, a motion sensing portion 229, a lighting portion 220, and a communication portion 233.

The housing portion 219 is a part forming a body of the overhead console apparatus 200 (that is, an exterior of the overhead console). The housing portion 219 may be mounted on a ceiling of the vehicle near a room mirror of the vehicle. That is, the housing portion 219 may be mounted on a front ceiling inside the vehicle. The housing portion 219 may be adjusted in shape and form to form a part of the ceiling of the vehicle in an area on which the housing portion 219 is mounted. The housing portion 219 may include an accommodating space (not shown) for accommodating glasses, sunglasses, etc.

The ion generator 216 may be provided in the housing portion 219. The ion generator 216 generates at least one of negative ions and positive ions. The ion generator 216 may operate in connection with a contamination degree inside the vehicle. For example, the ion generator 216 may be embodied to operate when the contamination degree inside the vehicle exceeds a reference value. Also, the ion generator 216 may control an ion generation amount or ion concentration according to the contamination degree inside the vehicle.

The air freshening device 218 may be provided in the housing portion 219. The air freshening device 218 generates an aroma. The air freshening device 218 may include a plurality of air fresheners. The air freshening device 218 may generate any one aroma according to a selection of a passenger in the vehicle. Here, the overhead console apparatus 200 may include a user interface (not shown) for receiving a command of the passenger.

The fan 255 may be provided in the housing portion 219. The fan 255 may be provided in the rear of the ion generator 216 and the air freshening device 218 in the housing portion 219. The fan 255 may blow ions generated by the ion generator 216 toward an air outlet portion 210. The ions discharged from the air outlet portion 210 purify the air inside the vehicle by sterilizing various types of bacteria and molds inside the vehicle and deodorizing the air inside the vehicle. The fan 255 may blow the aroma generated by the air freshening device 218 toward the air outlet portion 210. In this case, as the aroma generated by the air freshening device 218 fills the vehicle, an odor in the vehicle may be removed and a mood of the passenger inside the vehicle may be refreshed. The fan 255 may operate in connection with operations of the ion generator 216 and the air freshening device 218. For example, the fan 255 may be turned on when the ion generator 216 and the air freshening device 218 are turned on and may be turned off when the ion generator 216 and the air freshening device 218 are turned off. The fan 255 may control wind strength depending on a contamination degree inside the vehicle. The fan 255 may allow the air inside the vehicle to flow into the housing portion 219 through an air inlet portion 206. The fan 255 may operate according to dust concentration information transferred from the communication portion 233 and may allow the air inside the vehicle to flow into the housing portion 219. Here, the fan 255 may be adjusted in operation intensity depending on the dust concentration information.

Here, the ion generator 216, the air freshening device 218, and the fan 255 have been described as being provided inside the housing portion 219 but are not limited thereto and may be provided outside the housing portion 219 and fluidly connected to the housing portion 219 to discharge the ions generated by the ion generator 216 and the aroma generated by the air freshening device 218 through the air outlet portion 210.

The UV emitting portion 214 may be provided inside the housing portion 219. The UV emitting portion 214 emits UV rays into the housing portion 219. In detail, the UV emitting portion 214 may emit UV rays toward the photocatalyst portion 221 provided in the housing portion 219.

The photocatalyst portion 221 may be provided inside the housing portion 219. The photocatalyst portion 221 may react to UV rays emitted by the UV emitting portion 214 and may generate a sterilizing material. For example, the photocatalyst portion 221 may be formed by coating a part (or the entire) of an inner wall of the housing portion 219 with at least one photocatalyst among titanium dioxide, zinc oxide, cadmium sulfide, and tungsten oxide. However, the type of the photocatalyst is not limited thereto. When UV rays are emitted to the photocatalyst portion 221, the photocatalyst portion 221 generates sterilizing materials such as hydroxy radical and super oxide which have strong oxidizing power. Hydroxy radical and super oxide described above oxidize and decompose contaminants in the air inside the vehicle to sterilize. Here, the fan 255 may blow the sterilizing material generated by the photocatalyst portion 221 toward the air outlet portion 210 to discharge the sterilizing material into the vehicle.

The ion generator 216 and the UV emitting portion 214 may selectively operate and may operate at the same time. That is, the overhead console apparatus 200 may selectively discharge the ions and the sterilizing material into the vehicle or may discharge the ions and the sterilizing material at the same time to make a sterilizing atmosphere inside the vehicle.

The dust filter 223 may be provided inside the housing portion 219. The dust filter 223 may filter the air inside the vehicle which flows into the housing portion 219 due to the fan 255. The air inside the vehicle which flows into the air inlet portion 206 due to the fan 255 passes through an internal space of the housing portion 219 and is discharged through the air outlet portion 210. Here, the dust filter 223 may be provided to allow an adsorption surface of the dust filter 223 to intersect with a moving direction of the air inside the vehicle in the housing portion 219. The dust filter 223 may be provided while occupying the entire path which intersects with the moving direction of the air inside the vehicle in the housing portion 219. In this case, since the air inside the vehicle passes through the dust filter 223 and is discharged through the air outlet portion 210, the air filtered by the dust filter 223 is discharged into the vehicle again. The dust filter 223 filters out fine dust, yellow dust, foreign substances, etc. included in the air inside the vehicle.

The overhead console apparatus 200 may include a filter sterilizing portion which sterilizes the dust filter 223. Here, the filter sterilizing portion may include the photocatalyst portion 221 provided at the dust filter 223 and the UV emitting portion 214 which emits UV rays to the dust filter 223. The photocatalyst portion 221 may be formed by coating the dust filter 223 with at least one photocatalyst among titanium dioxide, zinc oxide, cadmium sulfide, and tungsten oxide. When the UV emitting portion 214 emits UV rays toward the dust filter 223, the photocatalyst portion 221 provided at the dust filter 223 may generate a sterilizing material to sterilize the dust filter 223 itself or the generated sterilizing material may be discharged into the vehicle to sterilize the inside of the vehicle.

An air path portion is formed at the housing portion 219. The air path portion is formed while connecting the inside of the vehicle to the inside of the housing portion 219. The air path portion may include the air outlet portion 210 and the air inlet portion 206. The air outlet portion 210 may be formed at a front end of the housing portion 219. At least one of the ions generated by the ion generator 216, the aroma generated by the air freshening device 218, the sterilizing material generated by the photocatalyst portion 221, and the air filtered by the dust filter 223 is discharged into the vehicle through the air outlet portion 210. The air inlet portion 206 may be formed at a rear end of the housing portion 219. The air inside the vehicle may flow into the housing portion 219 through the air inlet portion 206. Here, the air outlet portion 210 has been described as being formed at the front end of the housing portion 219 and the air inlet portion 206 has been described as being formed at the rear end of the housing portion 219 but are not limited thereto and the air outlet portion 210 may be formed at the rear end of the housing portion 219 and the air inlet portion 206 may be formed at the front end of the housing portion 219. Also, here, the air outlet portion 210 and the air inlet portion 206 have been described as being formed to face each other but are not limited thereto and the air outlet portion 210 may be formed at the front end of the housing portion 219 and the air inlet portion 206 may be formed on one side of the housing portion 219.

The notification portion 227 may notify an operation state of the overhead console apparatus 200. For example, the notification portion 227 may notify whether the ion generator 216, the air freshening device 218, the fan 255, and the UV emitting portion 214 operate (that is, whether they are turned on or off). The notification portion 227 may notify concentration or an amount of ions generated by the ion generator 216 while the ion generator 216 operates. The notification portion 227 may notify the kind of an aroma generated by the air freshening device 218 while the air freshening device 218 operates. The notification portion 227 may notify the concentration of a sterilizing material generated by the photocatalyst portion 221 while the UV emitting portion 214 operates. The notification portion 227 may notify air blowing intensity of the fan 255 while the fan 255 operates. The notification portion 227 may notify an operation state of the overhead console apparatus 200 by displaying the operation state on a screen or outputting the operation state as a voice. The notification portion 227 may be provided at the housing portion 219 but is not limited thereto and may be provided near the overhead console apparatus 200.

The motion sensing portion 229 may sense a movement (or a motion) of the passenger. The motion sensing portion 229 may include a camera which takes an image of the passenger. Here, the camera may recognize a particular part of the passenger (for example, a hand, a finger, etc.) and may take an image of only the particular part. The motion sensing portion 229 may sense various preset movements of the passenger and may generate motion sensing signals corresponding to the movements to the lighting portion 220. The motion sensing portion 229 may be provided at the housing portion 219 but is not limited thereto and may be provided near the overhead console apparatus 200.

The lighting portion 220 may be provided in the housing portion 219. The lighting portion 220 may operate according to the movement of the passenger. That is, the lighting portion 220 may operate according to the motion sensing signal of the motion sensing portion 229. When the passenger makes a preset motion, the lighting portion 220 may operate according to an operation manual matched with the corresponding motion (for example, on or off operation, brightness level adjustment, color temperature level adjustment, etc.). For example, the lighting portion 220 may be turned on according to a first preset operation sensed by the motion sensing portion 229 and may be turned off according to a second preset operation sensed by the motion sensing portion 229. The lighting portion 220 may be turned on for a preset time according to a preset operation sensed by the motion sensing portion 229 and then turned off. The lighting portion 220 may be adjusted in at least one of brightness and a color temperature depending on a preset operation sensed by the motion sensing portion 229 while being turned on.

Meanwhile, the lighting portion 220 may operate depending on a distance from a part of the body of the passenger. Here, the overhead console apparatus 200 may include a sensor (for example, an infrared sensor, an ultrasound sensor, etc.) for measuring the distance from the part of the body of the passenger. For example, the lighting portion 220 may be turned on when the distance from the part of the body of the passenger becomes a preset distance or less. Also, when the distance from the part of the body of the passenger becomes the preset distance or less while the lighting portion 220 is turned on, the lighting portion 220 may be turned off. Also, the lighting portion 220 may be turned on when a level of illumination inside the vehicle is a preset illumination level or less. Here, the overhead console apparatus 200 may include an illumination level sensor which measures the level of illumination inside the vehicle.

The communication portion 233 may receive dust concentration information of an area corresponding to a position of the vehicle. For example, the communication portion 233 may receive position information of the vehicle from a GPS installed in the vehicle and may request dust concentration information of the corresponding area by transmitting the received position information of the vehicle to an external server (that is, a server which manages the dust concentration information of the corresponding area). When the communication portion 233 receives the dust concentration information of the corresponding area according to the position of the vehicle, the overhead console apparatus 200 may operate the fan 255 depending on the dust concentration information of the corresponding area. Here, the overhead console apparatus 200 may adjust air blowing intensity (operation intensity) of the fan 255 according to the dust concentration information of the corresponding area. Hereinafter, a case of classifying dust concentration into stages such as “good”, “ordinary”, “little bad”, “bad”, and “very bad” will be described. For example, when the dust concentration information of the corresponding area is “little bad” or less, the overhead console apparatus 200 operates the fan 255 and starts filtering the air inside the vehicle using the dust filter 223. Here, when the dust concentration information of the corresponding area is in a state worse than “little bad” (for example, “bad” or “very bad”), the operation intensity of the fan 255 becomes stronger to increase a speed of filtering the air inside the vehicle. The communication portion 233 may be provided at the housing portion 219 but is not limited thereto and may be provided outside the overhead console apparatus 200. Here, the communication portion 233 may transmit the dust concentration information of the corresponding area according to the position of the vehicle to the control portion 217 of the overhead console apparatus 200.

As described above, the overhead console apparatus 200 is provided at an overhead console, thereby sterilizing the inside of the vehicle and purifying the air inside the vehicle through the overhead console separate from an air conditioning apparatus inside the vehicle. An air cleaning function (discharging ions, discharging the sterilizing material, filtering the air inside the vehicle, etc.) of the overhead console may be operated in connection with whether the ignition of the vehicle is turned on. For example, the air cleaning function of the overhead console may be operated in connection with turning on the ignition of the vehicle and may be stopped in connection with turning off the ignition of the vehicle. In this case, while the vehicle is driven, an environment inside the vehicle remains in a clean state due to the overhead console.

Meanwhile, the control portion 217 may control the ion generator 216, the air freshening device 218, the fan 255, the UV emitting portion 214, the notification portion 227, the motion sensing portion 229, the lighting portion 220, and the communication portion 233. The control portion 217 may be provided at a main board (not shown) mounted in the housing portion 219. In detail, the control portion 217 may receive contamination degree information inside the vehicle from the contamination measuring portion 213 provided inside the vehicle and may control an operation of the ion generator 216. Here, the control portion 217 may adjust an ion generation amount or ion concentration of the ion generator 216 depending on the contamination degree information inside the vehicle. The control portion 217 may control the air freshening device 218 to generate an aroma of an air freshener selected by the passenger among a plurality of air fresheners according to a command of the passenger input from a user interface (not shown). The control portion 217 may operate the UV emitting portion 214 to allow the photocatalyst portion 221 to generate a sterilizing material depending on the contamination degree information inside the vehicle. The control portion 217 may operate the fan 255 at the same time when at least one of the ion generator 216, the air freshening device 218, and the UV emitting portion 214 is operated. Also, the control portion 217 may control air blowing intensity of the fan 255 depending on the contamination degree information inside the vehicle. The control portion 217 may operate the fan 255 to allow the air inside the vehicle to flow into the housing portion 219 depending on the dust concentration information of the corresponding area according to the position of the vehicle. The control portion 217 may control the operation intensity of the fan 255 depending on the dust concentration information. Here, the control portion 217 has been described as operating the ion generator 216, the air freshening device 218, the fan 255, the UV emitting portion 214, etc. depending on the contamination degree information inside the vehicle or the dust concentration information of the corresponding area but is not limited thereto and may operate the ion generator 216, the air freshening device 218, the fan 255, the UV emitting portion 214, etc. according to the command of the passenger input from the user interface. The control portion 217 may notify the passenger of the operation state of the overhead console apparatus 200 by controlling the notification portion 227. The control portion 217 may control an operation of the lighting portion 220 according to the motion sensing signal generated by the motion sensing portion 229. For example, when a motion sensing signal is generated by the motion sensing portion 229, the control portion 217 extracts an operation manual of the lighting portion 220 corresponding to the motion sensing signal from a storage medium and then may control the operation of the lighting portion 220 according to the extracted operation manual. The control portion 217 may control the communication portion 233 to receive the dust concentration information of the corresponding area according to the position of the vehicle.

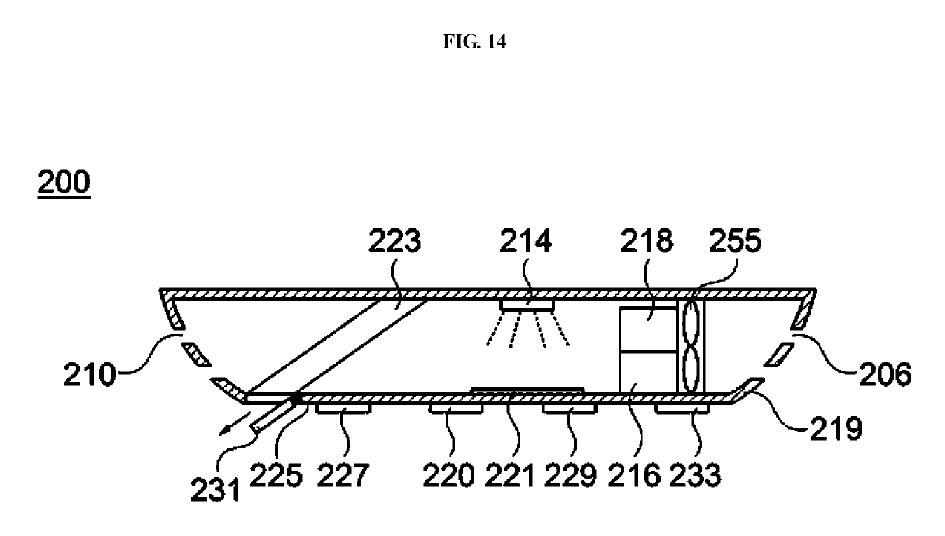

FIG. 14 is a schematic diagram illustrating an overhead console apparatus according to another embodiment of the present invention. Here, parts different from one embodiment shown in FIG. 13 will be mainly described.

Referring to FIG. 14, the dust filter 223 may be provided inside the housing portion 219 to incline. In this case, an area in which the air inside the vehicle which flows into the housing portion 219 is adsorbed onto the dust filter 223 may be increased. The dust filter 223 may be provided inside the housing portion 219 to be replaceable. For example, a filter cover 231 formed to be capable of being opened and closed may be provided at the housing portion 219 at which a bottom end of the dust filter 223 is positioned. The filter cover 231 may be hinge-coupled with the housing portion 219 using a hinge 225 formed on one side of the filter cover 231. Here, the filter cover 231 has been described as being hinge-coupled with the housing portion 219 but is not limited thereto and may be slide-coupled with the housing portion 219. The bottom end of the dust filter 223 may be supported by the filter cover 231. Here, the dust filter 223 may be withdrawn from the housing portion 219 when the filter cover 231 is opened, thereby easily replacing the dust filter 223. Meanwhile, when the dust filter 223 is mounted in the housing portion 219, the control portion 217 may count a mounting time of the dust filter 223. When the mounting time of the dust filter 223 exceeds a preset time, the control portion 217 may notify that it is necessary to replace the dust filter 223 using the notification portion 227.

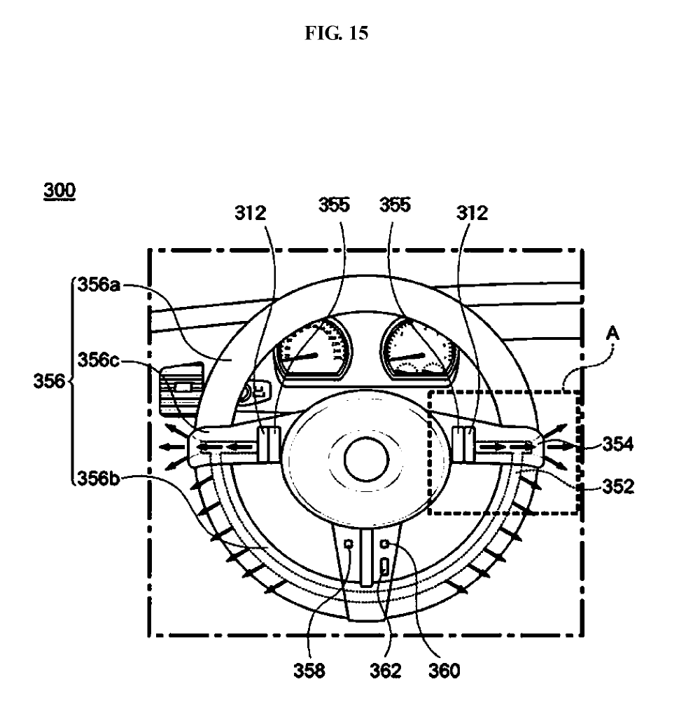

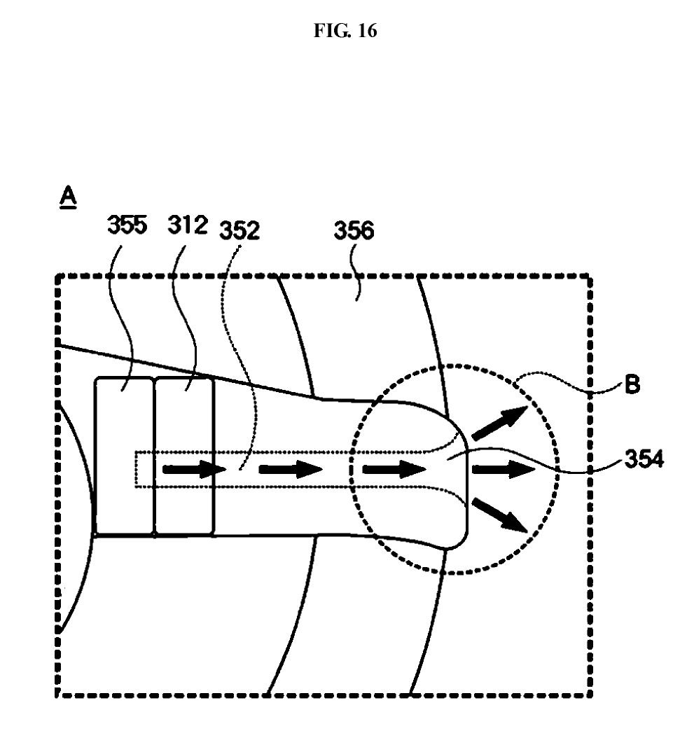

FIG. 15 is a view of a steering wheel apparatus for a vehicle according to an embodiment of the present invention, and FIG. 16 is an enlarged view of part A of FIG. 15. Here, a case in which an air cleaning apparatus is applied to a steering wheel apparatus of a vehicle will be described as an example.

Referring to FIGS. 15 and 16, a steering wheel apparatus 300 for a vehicle may include a fan 355, a heat exchange module 312, an air movement path 352, an air outlet 354, a frame 356, an input portion 358, a power supply portion 360, and a manipulation switch portion 362.

The fan 355 is formed on one side of the steering wheel and blows air inside the vehicle into the steering wheel. The fan 355, for example, may be formed on the frame 356 of the steering wheel. At least one air inlet (not shown) may be formed on one end of the fan 355 and may allow the air inside the vehicle to flow into the steering wheel through the air inlet. Also, the fan 355 may be connected to an air conditioning unit (not shown) of the vehicle. In this case, the fan 355 may suction air from the air conditioning unit of the vehicle and may blow the air into the steering wheel.

The fan 355 may receive power from the power supply portion 360 to be operated. Here, the fan 355 may operate only during a reservation time input from a user through the input portion 358 which will be described below. For example, when the user sets the reservation time to allow the fan 355 to operate only from 8:00 am to 9:00 am through the input portion 358, the fan 355 may operate only during the corresponding reservation time. However, an operation mode of the fan 355 is not limited thereto and it may be configured to operate, for example, when the ignition of the vehicle is turned on.

The fan 355 allows the air inside the vehicle to flow into the air movement path 352. As will be described below, the heat exchange module 312 may be formed on the air movement path 352 and may heat-exchange the air blown from the fan 355. Also, the fan 355 may be connected to an external hot wire (not shown), may heat-exchange the air inside the vehicle, and may supply the heat-exchanged air to the heat exchange module 312. In this case, the air heat-exchanged by the external hot wire may be doubly heat-exchanged, thereby increasing a heat exchange effect.

Meanwhile, an ion generator (not shown) may be formed on one side of the fan 355. The ion generator generates at least one of negative ions and positive ions. Ions generated by the ion generator may flow into a steering wheel along the air inlet of the fan 355 and may sterilize and deodorize various bacteria and molds in the air movement path 352. That is, the ion generator may purify the air in the air movement path 352.

The heat exchange module 312 heat-exchanges with the air blown from the fan 355. The heat exchange module 312 may be formed in the steering wheel and may be adjacent to the fan 355. Also, the heat exchange module 312 may be formed on the air movement path 352. The heat exchange module 312 may heat or cool air using an internal heater (not shown) or a cooling fin. Also, the heat exchange module 312 may improve heat exchange efficiency using an internal thermoelectric element (not shown). After heating or cooling the air, the heat exchange module 312 may supply the heat-exchanged air to the air movement path 352.

The air movement path 352 provides a movement path of the air blown from the fan 355. The air movement path 352 may extend along the frame 356 of the steering wheel inside the steering wheel. For example, when the frame 356 of the steering wheel is formed in a donut shape, the air movement path 352 may also be formed in a donut shape. Also, as shown in FIG. 15, when the frame of the steering wheel includes an upper frame 356a, a lower frame 356b, and an inside frame 356c, the air movement path 352 may be formed only in the inside frame 356c and the lower frame 356b. That is, it is sufficient for the air movement path 352 to extend along an extension direction of the frame 356 inside the steering wheel to be formed corresponding to a part of the frame 356.

The air movement path 352 may include a metal material with high thermal conductivity such as aluminum, copper, steel, etc. Accordingly, a thermal loss of cool air or warm air which moves through the air movement path 352 may be prevented. The air movement path 352 described above may be insertion-injection molded in the frame 356 of the steering wheel while the steering wheel is manufactured. That is, the air movement path 352 and the frame 356 may be inserted in a mold together and a resin may be injected thereinto, thereby integrating the air movement path 352 with the frame 356.

Meanwhile, a plurality of hot wires (not shown) may be formed in the air movement path 352. The hot wires, for example, may extend along a longitudinal direction of the air movement path 352. In this case, heat transfer efficiency may be improved by increasing a contact area with the heat-exchanged air. The fan 355 may be connected to the hot wires in the air movement path 352 and may heat-exchange the air which flows into the steering wheel. In this case, the air which flows into the steering wheel may be doubly heat-exchanged by the hot wires in the air movement path 352 and a heat exchange fin (not shown) positioned on one side of the fan 355. Also, a sheet heater (not shown) disposed to be in contact with the air movement path 352 may heat the air which flows into the steering wheel.

The air outlet 354 is formed on at least one side of the air movement path 352 and discharges the heat-exchanged air outward from the steering wheel. A plurality of such air outlets 354 may be formed along an extension direction of the air movement path 352. For example, when the air movement path 352 extends in a donut shape, the air outlet 354 may also extend in a donut shape. As described above, the air movement path 352 may extend along the frame 356 inside the steering wheel. Similarly, the plurality of air outlets 354 may be formed at a certain interval on the air movement path 352 to correspond to the shape of the frame 356. However, the air outlets 354 do not need to be formed to correspond to the entire shape of the frame 356 and may be formed to correspond to a partial shape of the frame 356.

That is, the air outlet 354 may be formed to be positioned at only a part of the steering wheel. For example, the plurality of air outlets 354 may extend to correspond to the shape of the lower frame 356b. In this case, the heat-exchanged air is discharged only through a bottom of the steering wheel. Since it is sufficient for the heat-exchanged air to be discharged only through the bottom of the steering wheel in the case of a user who generally touches the bottom of the steering wheel, unnecessary energy consumption may be reduced. Also, the air outlet 354, for example, may be formed to be positioned at each of one ends of a frame (not shown) in an H shape. Unlike as shown in FIG. 15, the inside frame may be formed in a shape in which an H is inclined at 90 degrees. In this case, the air outlet 354 may be formed to be positioned at each of one ends of the inside frame.

Also, as will be described below, an air blowing position of the air outlet 354 may be adjusted using the manipulation switch portion 362. The user may freely adjust a position to which the heat-exchanged air is discharged. For example, when the user wants the heat-exchanged air to be discharged from a top of the steering wheel, the user may allow the heat-exchanged air to be discharged only through the air outlet 354 positioned at the top of the steering wheel using the manipulation switch portion 362. For this, an opening and closing portion (not shown) may be formed on one end of each of the air outlet 354. The opening and closing portion of the air outlet 354 may receive an electric signal from the manipulation switch portion 362 to open and close the corresponding air outlet 354. When the user manipulates the manipulation switch portion 362 not to allow the air outlet 354 positioned at the top of the steering wheel to discharge air, the opening and closing portion of the corresponding air outlet 354 may block an entrance of the corresponding air outlet 354. The user may manipulate opening and closing of the plurality of air outlets 354 separately or for each group using the manipulation switch portion 362.

The frame 356 is a structure forming a frame of the steering wheel, and as shown in FIG. 15, for example, may be configured to include a donut shape. The frame 356 may include the upper frame 356a, the lower frame 356b, and the inside frame 356c. As described above, the air movement path 352 may extend along the frame 356 inside the steering wheel. The air movement path 352 may be insertion-injection molded in the frame 356 while the steering wheel is manufactured. Also, the plurality of air outlets 354 may be formed at a certain interval to correspond to the shape of the frame 356.

The input portion 358 may receive a reservation time for operating the fan 355 from the user. As described above, the fan 355 may be configured to operate only during the reservation time input by the user through the input portion 358. That is, the fan 355 may operate in connection with the input portion 358. The input portion 358 may include a button for receiving the reservation time from the user. However, an input mode of the input portion 358 is not limited thereto and the user may input the reservation time through a touch mode.

The power supply portion 360 supplies power to the fan 355. The fan 355 may receive the power from the power supply portion 360 to be operated. Also, a disconnecting module (not shown) which automatically disconnects power supply to the fan 355 may be built into the power supply portion 360. When preset conditions are satisfied, the disconnecting module may disconnect the power supply of the power supply portion 360. For example, the disconnecting module may be configured to disconnect the power supply of the power supply portion 360 after a certain time (for example, after 10:00 am). Also, the disconnecting module may be configured to disconnect the power supply of the power supply portion 360 when a temperature of the power supply portion 360 exceeds a preset value (for example, 25 degrees). Accordingly, unnecessary energy consumption may be reduced by disconnecting the power supply of the power supply portion 360 when the user does not get into the vehicle. However, the conditions for disconnecting power supply of the disconnecting module are merely an example and the power supply of the power supply portion 360 may be automatically disconnected in various conditions. The disconnecting module may be embodied as a hardware or software form for automatically disconnecting the power supply of the power supply portion 360 inside the power supply portion 360.

The manipulation switch portion 362 is a switch for adjusting at least one of an air blowing position, an air blowing intensity, and a temperature of the air discharged through the air outlets 354.

First, the user may adjust the air blowing position of the air discharged through the air outlet 354 by manipulating the manipulation switch portion 362. As described above, the plurality of air outlets 354 may be formed while being spaced apart at a certain interval to correspond to the shape of the frame of the steering wheel. The user may select an air outlet 354 among the plurality of air outlets 354 desired to actually discharge air using the manipulation switch portion 362. For example, the user may allow the air to be discharged only through the air outlet 354 positioned at the lower frame 356b using the manipulation switch portion 362. The opening and closing portion in the air outlet 354 may open and close the corresponding air outlet 354 in connection with the manipulation switch portion 362.

Also, the user may adjust the air blowing intensity of the air discharged through the air outlet 354 by manipulating the manipulation switch portion 362. For example, the user may increase or decrease the air blowing intensity of the air discharged through the air outlet 354 using the manipulation switch portion 362. The fan 355 may adjust the air blowing intensity in connection with the manipulation switch portion 362. Also, as described below, an air blowing module (not shown) may be formed at a position adjacent to the air outlet 354 and may blow the air discharged through the air outlet 354 outward from the steering wheel. The air blowing module, for example, may be formed at the bottom of the frame 356. In this case, the air blowing module may operate in connection with the manipulation switch portion 362. For example, when the user desires to increase the air blowing intensity of the air by manipulating the manipulation switch portion 362, the air blowing module may operate or the air blowing intensity of the air blowing module may increase.

In addition, the user may adjust the temperature of the air discharged through the air outlet 354 by manipulating the manipulation switch portion 362. For example, the user may increase or decrease the temperature of the air discharged from the air outlet 354 using the manipulation switch portion 362. For this, the heat exchange module 312 may operate in connection with the manipulation switch portion 362. For example, the heater of the heat exchange module 312 may operate when the user desires to increase the temperature of the air by manipulating the manipulation switch portion 362, and the cooling fin of the heat exchange module 312 may operate when the user desires to decrease the temperature of the air by manipulating the manipulation switch portion 362. That is, according to embodiments of the present invention, the air blowing position, the air blowing intensity, and the temperature of the air discharged outside the steering wheel may be adjusted using the manipulation switch portion 362, thereby efficiently blowing the air into the vehicle. The manipulation switch portion 362, for example, may be configured as a plurality of buttons or a touch panel through which the user may adjust the air blowing position, the air blowing intensity, and the temperature of the air.

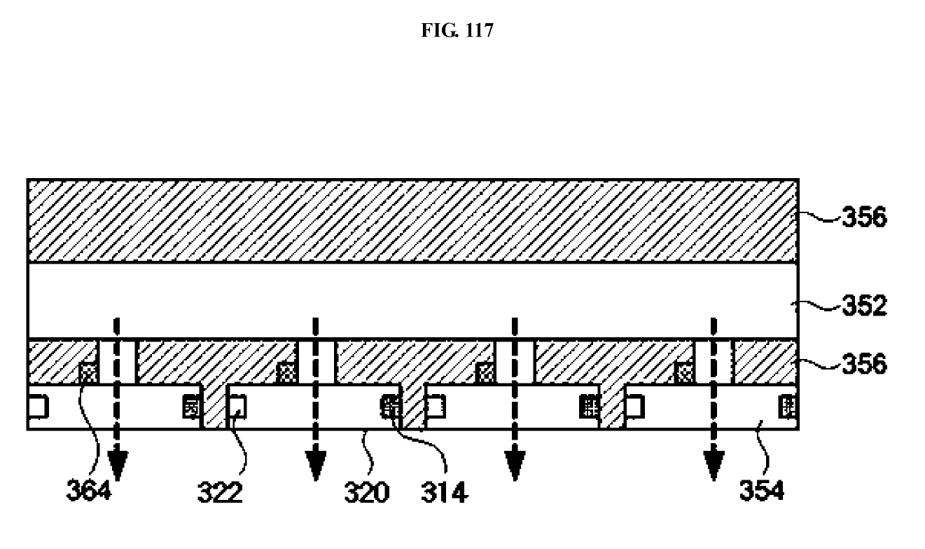

FIG. 17 is an enlarged view of part B of FIG. 16. As shown in FIG. 17, the plurality of air outlets 354 may be formed on at least one side of the air movement path 352.

Here, the air outlet 354 may be formed to be bent in a T shape or an L shape, or may extend as it approaches the outside of the steering wheel. That is, the air outlet 354 may be provided to allow a cross section of a portion connected to the air movement path 352 (one side of the air outlet 354) to be smaller than a portion connected to the outside of the steering wheel (the other side of the air outlet 354). The other side of the air outlet 354 may include an extending portion. The other side of the air outlet 354 may gradually extend from the one side of the air outlet 354.

The steering wheel is a portion directly abutting a hand of the user. In embodiments of the present invention, the air outlet 354 is formed to be bent in the T shape or the L shape or extends as it approaches the outside of the steering wheel, thereby fundamentally preventing a possibility that the air outlet 354 is blocked by the hand of the user. The air outlet 354, for example, may be formed to allow an outermost entrance thereof to be two or three times larger than a diameter of a finger of the user.

Also, due to the shape of the air outlet 354, air may be diffused in various directions in the extending portion. Due to this, the heat-exchanged cool air or warm air may be diffused in a range broader than the inside of the vehicle.

Also, an air blowing module 364 for discharging air may be formed on one side of the frame 356 adjacent to the air outlet 354. As described above, the air blowing module 364 may blow the air discharged from the air outlet 354 outward from the steering wheel. Accordingly, the air outlet 354 may more easily discharge the air. Also, as described above, the air blowing module 364 may operate in connection with the manipulation switch portion 362. The air blowing module 364 may receive an electric signal from the manipulation switch portion 362 and may operate.

Also, one or more lighting portions 320 may be formed at the air outlet 354. The lighting portions 320, for example, may be formed along a rim of the entrance of the air outlet 354. However, a position at which the lighting portion 320 is formed is not limited thereto, and it may be formed inside the air outlet 354.

As the heat-exchanged air is discharged from the air outlet 354, the lighting portions 320 emit light. Here, the lighting portions 320 may emit light in different colors according to the air blowing intensity or the temperature of the air discharged from the air outlet 354. For example, a brightness of the lighting portions 320 may be embodied as gradually brightening or dimming according to the air blowing intensity or the temperature of the air blown from the air outlet 354. Also, a color temperature of the lighting portions 320 may be embodied as gradually changing from a cool color temperature (for example, 5,000 to 8,000 K) to a warm color temperature (for example, 1,000 to 4,000 K) or gradually changing from a warm color temperature to a cool color temperature according to the air blowing intensity or the temperature of the air blown from the air outlet 354. For this, the lighting portion 320 may receive air blowing intensity and temperature information of the air discharged from the air outlet 354 in connection with the manipulation switch portion 362 and may operate according thereto.

A UV emitting portion 314 may be formed on one side of the air outlet 354. The UV emitting portion 314 may emit UV rays toward the air outlet 354 and accordingly may sterilize the air outlet 354. One or more of such UV emitting portions 314 may be formed on one side of the corresponding air outlet 354.

In addition, an ozone generator 322 may be formed on the other side of the air outlet 354. The ozone generator 322 may generate ozone at the air outlet 354 and may sterilize the air outlet 354.

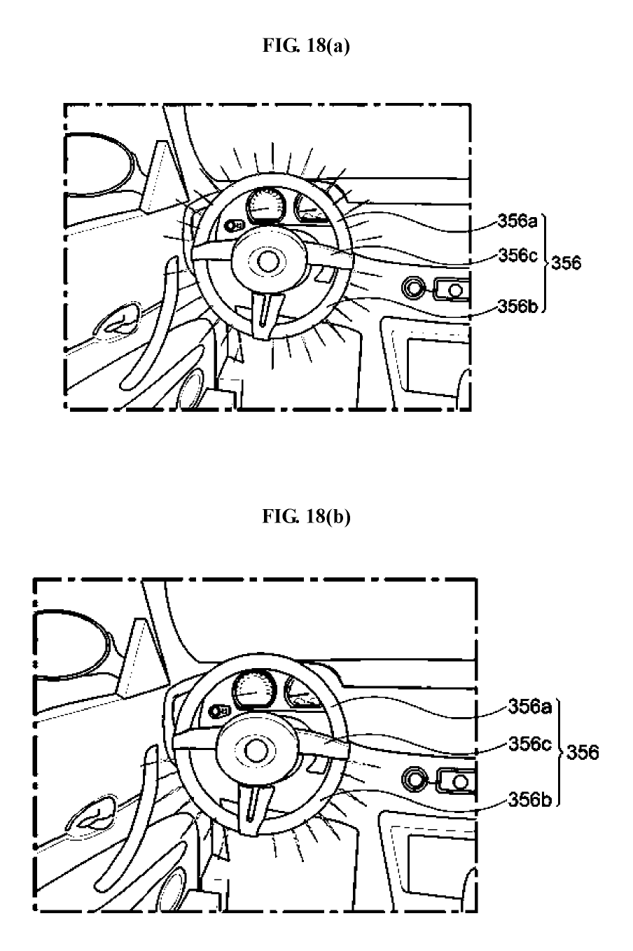

FIG. 18 is a view illustrating a state in which heat-exchanged air is discharged from a particular part of the steering wheel apparatus according to the embodiment of the present invention. As shown in FIG. 18, the frame 356 of the steering wheel, for example, may include the upper frame 356a, the lower frame 356b, and the inside frame 356c.

As shown in FIG. 18(a), cool air or warm air may be discharged through the air outlets 354 formed at positions corresponding to the upper frame 356a and the lower frame 356b.

Also, as shown in FIG. 18(b), cool air or warm air may be discharged through the air outlets 354 formed at positions corresponding to the lower frame 356b. As described above, the user may select the air blowing position of the air discharged from the air outlet 354 using the manipulation switch portion 362. The opening and closing portion may be formed at one end of the air outlet 354 and may receive an electric signal from the manipulation switch portion 362 to open and close the corresponding air outlet 354. When the user operates the manipulation switch portion 362 to allow the air to be discharged from the air outlet 354 formed at the position corresponding to the lower frame 356b, the opening and closing portions of the air outlets 354 at different positions except the lower frame 356b may block the entrances of the corresponding air outlets 354. As described above, the user may manipulate an opening and closing of the plurality of air outlets 354 separately or for each group using the manipulation switch portion 362. That is, the user may freely select the air blowing position of the cool air or the warm air discharged from the steering wheel by manipulating the manipulation switch portion 362.

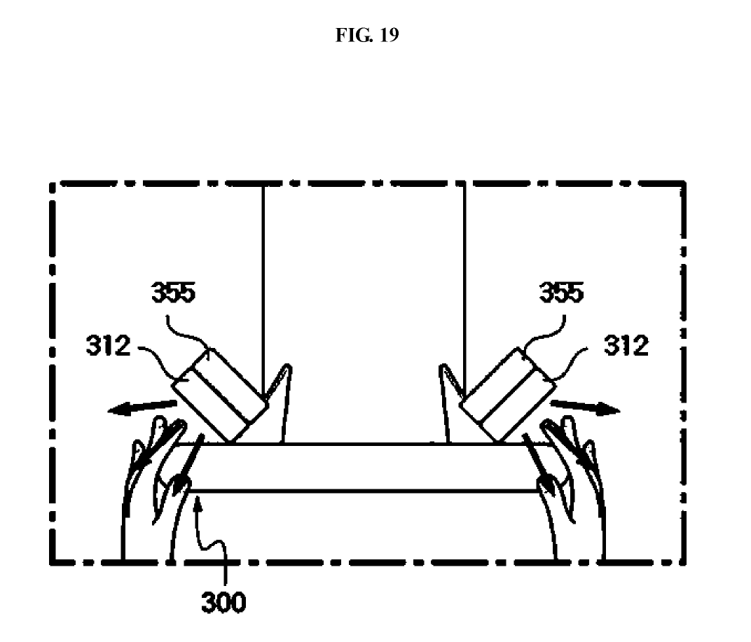

FIG. 19 is a view illustrating another example in which air heat-exchanged by the steering wheel apparatus according to the embodiment of the present invention is discharged. As shown in FIG. 19, the fan 355 and the heat exchange module 312 may be attached to one side of the steering wheel. In this case, the air movement path is not formed inside the steering wheel and cool air or warm air may be discharged by the fan 355 and the heat exchange module 312 attached to the one side of the steering wheel toward the user. That is, as shown in FIG. 19, the user may receive heat-exchanged air while grasping the steering wheel.

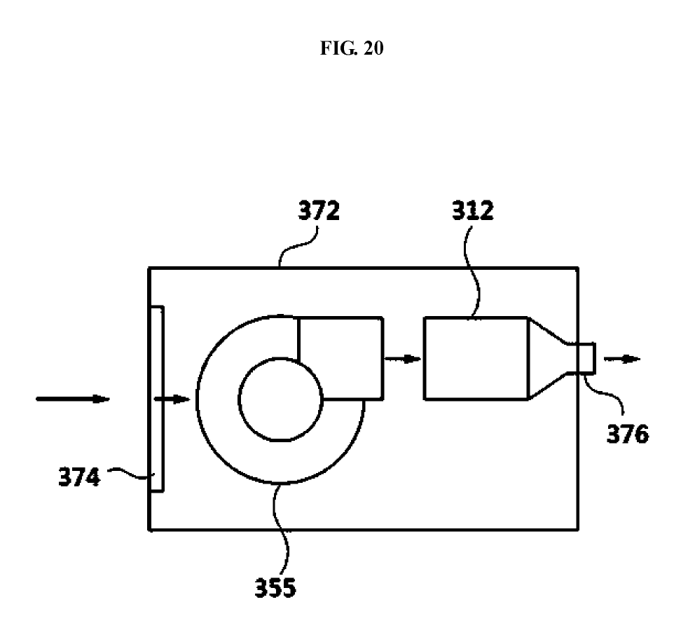

FIG. 20 is a view illustrating a process in which air inside the vehicle flows into the air movement path in the steering wheel apparatus according to the embodiment of the present invention.

As shown in FIG. 20, the fan 355 and the heat exchange module 312 may be surrounded by a housing portion 372. The housing portion 372 surrounds and serves to protect the fan 355 and the heat exchange module 312 from an external shock. The housing portion 372 may be formed inside the steering wheel.

An air inlet 374 may be formed on one side of the housing portion 372. The fan 355 may allow the air inside the vehicle to flow into the steering wheel through the air inlet 374. After that, the fan 355 may blow the inflowing air toward the heat exchange module 312. An air outlet 376 may be formed on the other side of the housing portion 372 (that is, a side opposite the one side of the housing portion 372). As shown in FIG. 20, the air outlet 376 may be formed to be adjacent to the heat exchange module 312 and may discharge air heat-exchanged by the heat exchange module 312 to the air movement path 352.

Meanwhile, the fan 355 may be configured to operate depending on an ambient temperature of the air inlet 374. For example, when the ambient temperature of the air inlet 374 becomes a preset reference temperature or less, the fan 355 may operate to allow the air inside the vehicle to flow into the steering wheel and may blow the air to the heat exchange module 312. Conversely, when the ambient temperature of the air inlet 374 exceeds the preset reference temperature, the fan 355 may operate to allow the air inside the vehicle to flow into the steering wheel and may blow the air to the heat exchange module 312.

The heat exchange module 312 may heat or cool the air blown from the fan 355. Here, the air which flows in the steering wheel comes into contact with the heat exchange module 312 while passing through the heat exchange module 312. That is, the air which flows in comes into contact with the heat exchange module 312 and is heat-exchanged therewith while moving along a longitudinal direction of the heat exchange module 312.

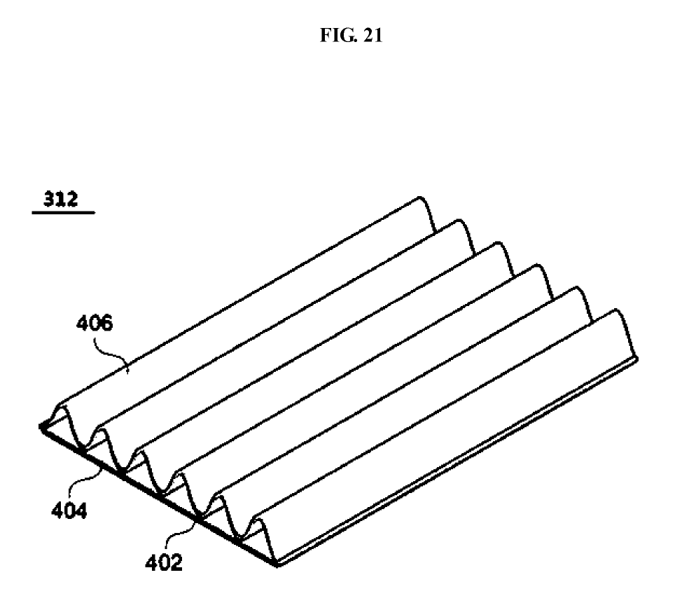

FIG. 21 is a perspective view of a heat exchange module according to the first embodiment of the present invention. In the following FIGS. 21 to 23, an example in which the heat exchange module 312 heats the air blown from the fan 355 will be described. As shown in FIG. 21, the heat exchange module 312 according to the first embodiment of the present invention may include a heater 402, a supporting plate 404, and a heat exchange portion 406.

The heater 402 includes a heating element (not shown) which generates heat. The heater 402 may generate heat throughout a certain area. Also, the heater 402 may be formed as a thin film shape. For example, a thickness of the heater 402 may be more than 0 and 1 mm or less. A lower limit of the thickness of the heater 402 may be adequately set according to materials of the heating element, an insulating member, etc. which form the heater 402 at a level of one of ordinary skill in the art. Thermal capacity of the heater 402 is reduced by manufacturing the heater 402 to be a thin film, thereby increasing a temperature of the heater 402 to a certain degree in a short time. In this case, power consumption of the heater 402 may be reduced. The heater 402, for example, may be a positive temperature coefficient (PTC) heater but is not limited thereto.

The heater 402 may include the heating element, a first insulating member (not shown) provided toe surround the heating element at one surface of the heating element, and a second insulating member (not shown) provided to surround the other surface of the heating element. The heating element may be provided throughout the whole area of the heater 402 to generate heat. For example, the heating element may be provided throughout the whole area of the heater 402 in a zigzag shape. As the heating element, for example, a metal thin film (or a metal thin plate) such as a stainless thin film, a platinum thin film, a tungsten thin film, a nickel thin film, etc. may be used. However, the heating element is not limited thereto and the heating element may also be formed by being coated with carbon nanotubes, carbon nano-plates, etc. The heating element may include a pad for receiving power from the outside. The first insulating member and the second insulating member may include a polyimide or graphene material. In this case, even though a temperature of the heating element increases to a high level or an external shock is applied, the heating element may be stably protected. The first insulating member and the second insulating member may be formed of film shapes. The first insulating member and the second insulating member may be attached to one surface and the other surface of the heating element, respectively.

The supporting plate 404 may be provided on one surface of the heater 402. That is, one surface of the supporting plate 404 (that is, a surface facing the heater 402) may be provided on the one surface of the heater 402. The supporting plate 404 may serve to support the heater 402. The supporting plate 404 may include a material with high thermal conductivity (for example, aluminum, copper, SUS, etc.). The supporting plate 404 may be formed as a thin film shape. For example, a thickness of the supporting plate 404 may be more than 0 and 1.5 mm or less. A lower limit of the thickness of the supporting plate 404 may be adequately set according to a material of the supporting plate 404 at a level of one of ordinary skill in the art. In this case, the supporting plate 404 may quickly transfer heat generated by the heater 402 to the heat exchange portion 406. The supporting plate 404 may be adhered to one surface of the heater 402. The heater 402 and the supporting plate 404 may be adhered using an adhesive paste including a thermally conductive powder. In this case, the heater 402 and the supporting plate 404 may be physically coupled and the heat generated by the heater 402 may be transferred to the supporting plate 404. Also, the heater 402 and the supporting plate 404 may be adhered using a polyimide adhesive. Also, the heater 402 and the supporting plate 404 may be coupled using a brazing method, a soldering method, etc. However, a coupling method is not limited thereto and the supporting plate 404 may be coupled with the heater 402 using various coupling methods. For example, the supporting plate 404 may be coupled with the heater 402 using methods such as riveting, screw-pressing, extruding, etc.

The heat exchange portion 406 may be provided at the supporting plate 404. The heat exchange portion 406 may be provided on the other surface of the supporting plate 404 (that is, a surface opposite the surface facing the heater 402). The heat exchange portion 406 may be brazed and coupled to the supporting plate 404. However, a coupling method is not limited thereto, the heat exchange portion 406 may be coupled with the supporting plate 404 using various coupling methods in addition thereto (for example, adhesion using the polyimide adhesive, connection using a solder, etc.). The heat exchange portion 406 may include a material with high thermal conductivity (for example, aluminum, copper, SUS, etc.). The heat exchange portion 406 may include the same material as that of the supporting plate 404 but is not limited thereto, and may include a different material from the supporting plate 404.

The heat exchange portion 406 serves to heat ambient air by exchanging heat with the ambient air. The heat exchange portion 406 may have a wrinkled shape. That is, the heat exchange portion 406 may have shape of extending in a longitudinal direction with a waveform shape in which a cross section of one side is repeated. For example, the heat exchange portion 406 may have one surface formed in a sine waveform. In this case, the heat exchange portion 406 may increase heat exchange efficiency by increasing a contact area with the ambient air. The heat exchange portion 406 may be formed as a thin film. For example, a thickness of the heat exchange portion 406 may be formed to be more than 0 and 0.5 mm or less. A lower limit of the thickness of the heat exchange portion 406 may be adequately set according to a material of the heat exchange portion 406 at a level of one of ordinary skill in the art.

As described above, since the heat exchange portion 406 has a thin thickness, the heat exchange portion 406 may be quickly heated by heat generated by the heater 402. Due to this, air around the heat exchange portion 406 may be quickly heated using the heat exchange portion 406. Here, the heat exchange portion 406 has been described as having a linear shape in the longitudinal direction but it is not limited thereto, and it may be provided to be bent in the longitudinal direction. For example, the heat exchange portion 406 may have a waveform shape repeated in the longitudinal direction.

Also, a heat exchange fin (not shown) may be formed inside the heat exchange portion 406 in the longitudinal direction of the heat exchange portion 406. In this case, heat exchange efficiency may be improved by increasing a contact area with outside air. The heater 402 and the heat exchange fin may be bonded using a bonding agent. Here, the bonding agent may be formed, for example, of a polyimide material.

According to the embodiment of the present invention, since the heater 402, the supporting plate 404, and the heat exchange portion 406 are formed as thin films, the temperature of the heater 402 may be increased to a target temperature and the heat generated by the heater 402 may be quickly transferred to the heat exchange portion 406 through the supporting plate 404 to heat the heat exchange portion 406. Also, the heat exchange portion 406 may be quickly heated to a target temperature to exchange heat with the air around the heat exchange portion 406.

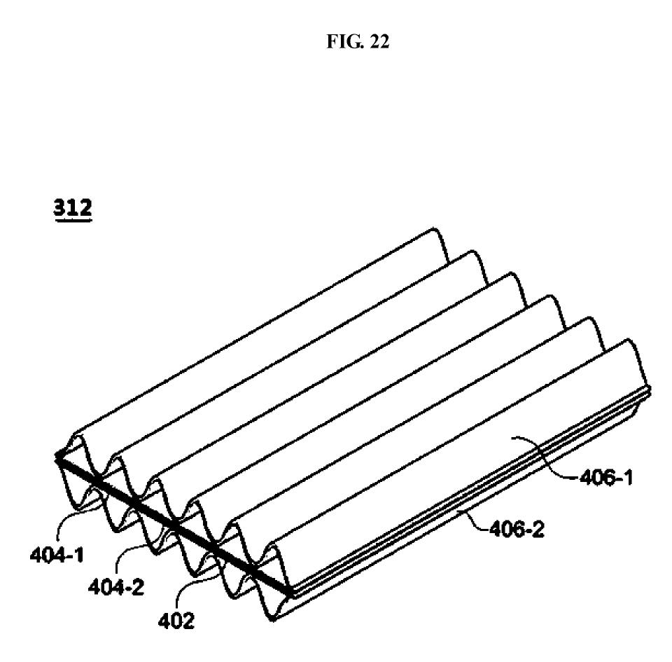

FIG. 22 is a perspective view of a heat exchange module according to the second embodiment of the present invention.

Referring to FIG. 22, the heat exchange module 312 may include the heater 402, a first supporting plate 404-1, a second supporting plate 404-2, a first heat exchange portion 406-1, and a second heat exchange portion 406-2.

The first supporting plate 404-1 may be provided on one surface of the heater 402, and the second supporting plate 404-2 may be provided on the other surface of the heater 402. The first heat exchange portion 406-1 may be provided at the first supporting plate 404-1, and the second heat exchange portion 406-2 may be provided at the second supporting plate 404-2. That is, one surface of the first supporting plate 404-1 may be provided on one surface of the heater 402, and the first heat exchange portion 406-1 may be provided on the other surface of the first supporting plate 404-1. Also, one surface of the second supporting plate 404-2 may be provide on the other surface of the heater 402, and the second heat exchange portion 406-2 may be provided on the other surface of the second supporting plate 404-2. The first supporting plate 404-1 and the second supporting plate 404-2 may include the same materials and may have the same thicknesses. Also, the first heat exchange portion 406-1 and the second heat exchange portion 406-2 may have the same shapes.

As described above, since the first heat exchange portion 406-1 and the second heat exchange portion 406-2 are provided on both surfaces of the heater 402, respectively, outside air which flows into the housing portion 372 may be heated by being heat-exchanged with the first heat exchange portion 406-1 and the second heat exchange portion 406-2. Due to this, a larger amount of the outside air may be heated and discharged. A plurality of such heat exchange modules 312 may be stacked.

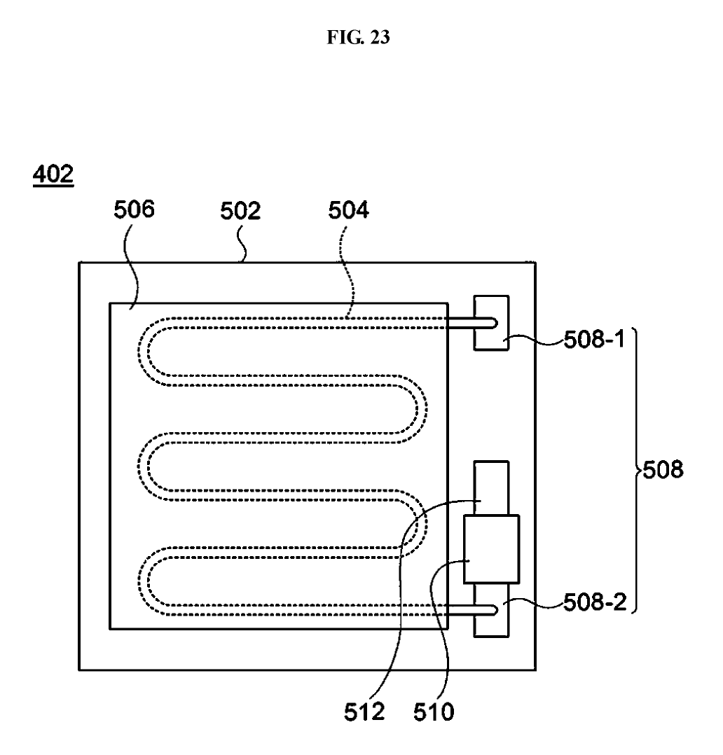

FIG. 23 is a view of a heater according to one embodiment of the present invention.

Referring to FIG. 23, the heater 402 may include a metal printed circuit board (PCB) 502, a heating element 504, an insulating portion 506, an electrode pad 508, a power supply disconnecting portion 510, and a temperature sensor 512.

The metal PCB 502 may include a metal base and an insulating layer provided on the metal base. The metal base, for example, may be formed of Aluminum, copper, SUS, etc.

The heating element 504 may be provided on the metal PCB 502. The heating element 504 may be provided on the insulating layer of the metal PCB 502. The heating element 504 may be provided in a zigzag shape on the metal PCB 502. As the heating element 504, a metal thin film such as a stainless thin film, a platinum thin film, a tungsten thin film, a nickel thin film, etc. may be used. A thickness of the heating element 504 may be formed to be more than 0 and 0.5 mm or less. A lower limit of the thickness of the heating element 504 may be adequately set according to a material of the heating element 504 at a level of one of ordinary skill in the art. As described above, a temperature of the heating element 504 may be quickly increased to a certain temperature using low power by using the heating element 504 of a thin film

The insulating portion 506 may be provided to surround the heating element 504 above the heating element 504. The insulating portion 506 may use, for example, a polyimide or graphene material, but is not limited thereto.

The electrode pad 508 may be provided on the metal PCB 502. The electrode pad 508 includes a first electrode pad 508-1 electrically connected to one end of the heating element 504 and a second electrode pad 508-2 electrically connected to the other end of the heating element 504. Lead wires for applying power may be connected to the first electrode pad 508-1 and the second electrode pad 508-2, respectively.

The power supply disconnecting portion 510 may be provided on the metal PCB 502. The power supply disconnecting portion 510 disconnects power supplied to the heating element 504 depending on a temperature measured by the temperature sensor 512. Here, the temperature sensor 512 measures a temperature of the heater 402. The power supply disconnecting portion 510 may be embodied as, for example, bimetal, etc. Here, the power supplied to the heating element 504 may be disconnected depending on the temperature of the heating element 504 without an additional temperature sensor.

Here, the insulating portion 506 is shown as being provided above the heating element 504 but is not limited thereto, and it may be provided above the electrode pad 508, the power supply disconnecting portion 510, and the temperature sensor 512. Also, here, the metal PCB 502 has been described as including the metal base and the insulating layer, and the heating element 504 and the electrode pad 508 have been described as being provided on the insulating layer of the metal PCB 502 but they are each not limited thereto, and the metal PCB 502 may include a metal base, an insulating layer provided on the metal base, and a metal layer provided on the insulating layer (for example, a copper thin film, etc.), and the heating element 504 and the electrode pad 508 may be provided by removing a part of the metal layer.

As described above, the heat exchange module 312 has been described as heating air blown from the fan 355 with reference to FIGS. 21 to 23, but may not only heat but also cool the air blown from the fan 355. For this, the heat exchange module 312 may include a cooling fin. The heat exchange module 312 may cool the air blown from the fan 355 using the cooling fin and then discharge the air to the air movement path 352. Also, the cooling fin may be included inside the fan 355. In this case, the fan 355 may cool the air using the cooling fin and may discharge the air to the air movement path 352. Here, the heat exchange module 312 may not operate.

While the inventive concept has been particularly shown and described with reference to embodiments thereof, it should be understood that various changes in form and details may be made therein without departing from the spirit and scope of the following claims. Therefore, the scope of the present invention is not limited to the embodiments described above but should be defined by the following claims and equivalents thereof.

### DESCRIPTION OF REFERENCE NUMERALS

100: Armrest apparatus for vehicle
102: Storage portion
104: Cover portion
104a: Lower cover case
104b: Upper cover case
106, 206: Air inlets
108: Air cleaning unit
108a: Dust filter
110, 210: Air outlet portions
112, 312: Heat exchange modules
114, 214, 314: UV emitting portions
116, 216: Ion generators
118, 218: Air freshening devices
120, 220, 320: Lighting portions
122, 322: Ozone generators
125: Hinge
127: Air hole
129: Supporting portion
131: Case
131-1: Front plate
131-2: Rear plate
131-3: Upper plate
131-4: Lower plate
133: Thermoelectric element
135: Heat exchange portion
141: Portable device accommodating groove
143: Wireless charging portion
145: Wired connecting portion
151: Accommodating portion
153: Holding portion
155, 255, 355: Fans
157: Air transfer portion
157-1: First air transfer portion
157-2: Second air transfer portion
200: Overhead console apparatus
201: Air cleaner
203: Reservation setting portion
205: Ignition state checking portion
207: Power supply portion
209: Power source switching portion
211: Power supply disconnecting portion
213: Contamination measuring portion
215: Event signal generating portion
217: Control portion
219: Housing portion
221: Photocatalyst portion
223: Dust filter
227: Notification portion
229: Motion sensing portion
231: Filter cover
233: Communication portion
300: Steering wheel apparatus for vehicle
352: Air movement path
354: Air outlet
356: Frame
356a: Upper frame
356b: Lower frame
356c: Inside frame
358: Input portion
360: Power supply portion
362: Manipulation switch portion
364: Air blowing module
372: Housing portion
374: Air inlet
376: Air outlet
402: Heater
404: Supporting plate
406: Heat exchange module
406-1: First heat exchange module
406-2: Second heat exchange module
502: metal PCB
504: Heating element
506: Insulating portion
508: Electrode pad
508-1: First electrode pad
508-2: Second electrode pad
510: Power supply disconnection portion
512: Temperature sensor

1-11. (canceled)

12. An air cleaning apparatus for a vehicle, comprising
an air clean module mounted in a vehicle,
wherein a controller includes
a reservation setting unit which receives reservation information which comprises at least one of operation starting information and operation time information of the air clean module and reserves an operation of the air cleaner according to the reservation information and
a control unit which controls the operation of the air clean module according to the reservation information is provided at one side of the air clean module or a center fascia of the vehicle.

13. The apparatus of claim 12, further comprising:
a power supply unit which supplies power to the apparatus; and
a power source switching unit electrically connected to any one power supply source of a battery of the vehicle and the power supply portion depending on whether the vehicle starts and allowing the apparatus to receive the power from the power supply source electrically connected to.

14. The apparatus of claim 13, wherein the power source switching unit is electrically connected to the power supply portion when an ignition of the vehicle is turned off and is electrically connected to the battery or a generating unit of the vehicle when the ignition of the vehicle is turned on.

15. The apparatus of claim 12, wherein the operation time information comprises an operation maintenance time of the air clean module, and
wherein the control unit changes the operation maintenance time of the operation time information according to a correlation between a contamination degree inside the vehicle and the operation maintenance time.

16. The apparatus of claim 12, wherein the control unit operates the air clean module according to the reservation information and controls operating the air clean module depending on whether at least one event of turning on the vehicle, unlocking a door lock of the vehicle, and sensing a smart key of the vehicle during a preset time between an operation starting point in time of the air clean module and an operation completion time of the air clean module according to the reservation information.

17-20. (canceled)

21. The apparatus of claim 12, wherein the air clean module includes a filter filtering foreign substance of air inside the vehicle, and
the filter is capable of being changed by opening formed at one side of an overhead console or an armrest of the vehicle.

22. An air cleaning apparatus for a vehicle, mounted in a console in the vehicle, comprising:
an air cleaning unit including a dust filter provided in the console and filtering air inside the vehicle and a fan suctioning the air inside the vehicle into the dust filter; and
an air outlet provided in the console and discharging the filtered air into the vehicle,
wherein the dust filter is capable of being changed by opening formed at the console,
the opening is opened or closed by rotating hingedly or sliding, and
the dust filter is inserted through the opening or into a body of the opening.

23. The apparatus of claim 22, further comprising a heat exchange module provided at the air outlet and including a heat exchanger to heat-exchange air passing through the air outlet (the air inside the vehicle or air supplied by an air conditioning unit of the vehicle).

24. An air cleaning apparatus for a vehicle, mounted on an internal structure of the vehicle selected from an armrest, a console, a seat, a headrest, an overhead console, a steering wheel, and a door, comprising:
an air inlet provided in the internal structure of the vehicle, through which air inside the vehicle flows in;
an air cleaning unit provided in the internal structure and filtering the air inside the vehicle which flows therein;
a first air flow path provided in the internal structure and through which the air, which flows in through the air inlet and is filtered by the air cleaning unit, is discharged into the vehicle; and
a second air flow path provided in the internal structure and through which blown air, which flows into the internal structure and does not pass through the air cleaning unit, is discharged into the vehicle.

25. The apparatus of claim 24, further comprising:
a first fan provided at the first air flow path and allowing the air inside the vehicle to flow into the air inlet portion; and
a second fan which allows at least one of the air inside the vehicle and the air discharged by the air conditioning unit of the vehicle to flow into the internal structure of the vehicle.

26. The apparatus of claim 24, wherein an air cleaning function of discharging the filtered air into the vehicle and an air blowing function of discharging the blown air into the vehicle are performed, which are reserved and operated in connection with whether a user getting in is detected.

27. The apparatus of claim 24, further comprising an air flow cushion portion provided in the internal structure of the vehicle wherein the filtered air or the blown air moves through the air flow cushion portion so that the filtered air or the blown air is discharged into the vehicle.

28. The apparatus of claim 24, further comprising a lighting unit provided in the internal structure of the vehicle,
wherein the lighting unit provides information related to the air inside the vehicle, the filtered air and the blown air.

29. An air cleaning apparatus for a vehicle mounted in an internal structure of the vehicle selected from an armrest, a console, a seat, a headrest, an overhead console, a steering wheel, and a door, comprising:
an air cleaning unit provided in the internal structure of the vehicle and suctioning and filtering air inside the vehicle;
an air outlet provided in the internal structure of the vehicle and discharging the filtered air into the vehicle; and
a heat exchange module provided at the air outlet and heat-exchanging with air which passes through the air outlet.

30. The apparatus of claim 29, further comprising an ultraviolet (UV) emitting unit provided in the internal structure of the vehicle and emitting UV rays toward the air cleaning unit,
wherein the air cleaning unit comprises a dust filter which filters the air inside the vehicle and comprises a photocatalyst reacting with the UV rays and generating a sterilizing material and a fan which allows the air inside the vehicle to flow into the dust filter and discharges the filtered air through the air outlet.

31. The apparatus of claim 29, further comprising a fan control unit which allows the filtered air to be discharged toward a seat in which a passenger sits among seats provided in the vehicle.

32. The apparatus of claim 29, wherein at least one of whether to operate and an operational intensity of the air cleaning unit is controlled depending on dust concentration information of a corresponding area according to a position of the vehicle.
